(19) United States
(12) Patent Application Publication
(10) Pub. No.: US 2025/0062924 A1
(43) Pub. Date: Feb. 20, 2025

(54) DATA PROCESSING METHOD AND APPARATUS FOR MULTI-BLOCKCHAIN, DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventor: Gengliang ZHU, Shenzhen (CN)

(21) Appl. No.: 18/940,503

(22) Filed: Nov. 7, 2024

Related U.S. Application Data
(63) Continuation of application No. PCT/CN2023/124071, filed on Oct. 11, 2023.

(30) Foreign Application Priority Data
Nov. 11, 2022 (CN) 202211411454.9

(51) Int. Cl. H04L 9/00; H04L 9/32

(52) U.S. Cl. CPC H04L 9/50; H04L 9/3265

(57) ABSTRACT

The present disclosure discloses a data processing method and apparatus for a multi-blockchain, a computer device, a computer-readable storage medium, and a computer program product. The method includes: obtaining chain height voting information of a management node of a target chain for a target service subchain; determining, when determining, based on a subchain control contract on the target chain, that the management node is a target registered node, a target chain height of the target service subchain based on the chain height voting information and the subchain control contract; and generating height confirmation information corresponding to the target chain height based on the subchain control contract, and transmitting the height confirmation information to a verification node in the target service subnetwork, to cause the verification node to write the target chain height into a subchain management contract on the target service subchain.

### CROSS-REFERENCES TO RELATED APPLICATIONS

This application is a continuation application of PCT Patent Application No. PCT/CN2023/124071, filed on Oct. 11, 2023, which claims priority to Chinese Patent Application No. 202211411454.9 filed on Nov. 11, 2022, the entire contents of both of which are incorporated herein by reference.

### FIELD OF THE TECHNOLOGY

The present disclosure relates to the field of blockchain technologies, and in particular, to a data processing method and apparatus for a multi-blockchain, a device, a computer-readable storage medium, and a computer program product.

### BACKGROUND OF THE DISCLOSURE

To meet requirements of service forms, a blockchain system may create service subchains for executing some subchain services (for example, temporary services generating a large amount of temporary data) based on a multi-blockchain architecture (for example, a three-chain architecture including a management chain, a bill chain, and an application contract chain).

A management and check mechanism supported by a blockchain system is generally embedded in a blockchain node included in the blockchain system or a related service contract, and is accordingly executed as a related transaction is packaged and chained. However, when the blockchain system creates a plurality of service subchains, such a manner apparently cannot adapt to flexible and variable management logic required by the different service subchains. In addition, when the service subchains are managed by using the management and check mechanism, normal subchain services on the service subchain are prone to blockage, which affects independent operation of the service subchains.

### SUMMARY

Embodiments of the present disclosure provide a data processing method and apparatus for a multi-blockchain, a computer device, a computer-readable storage medium, and a computer program product, to implement flexible management on a service subchain in a multi-blockchain architecture without affecting independent operation of the service subchain.

The embodiments of the present disclosure provide a data processing method for a multi-blockchain. The multi-blockchain includes a target chain and a target service subchain. A target chain network corresponding to the target chain is independent of a target service subnetwork corresponding to the target service subchain. The target service subnetwork is constructed by a target consensus node in the target chain network based on a target service requested by a service object. The method is performed by the target consensus node, and the method includes: obtaining chain height voting information of a management node associated with the target chain for the target service subchain, wherein a subchain control contract configured for controlling the target service subchain is deployed on the target chain, and the subchain control contract includes a target registered node performing identity registration for the target service subchain; determining, in response to determining, based on a subchain control contract on the target chain, that the management node is a target registered node, a target chain height of the target service subchain based on the chain height voting information and the subchain control contract; and generating height confirmation information corresponding to the target chain height based on the subchain control contract, and transmitting the height confirmation information to a verification node in the target service subnetwork, to cause the verification node to write the target chain height corresponding to the height confirmation information into a subchain management contract on the target service subchain, the subchain management contract being configured to instruct the verification node to determine, based on the target chain height, a chain height obtained after execution of the target service requested by the service object.

The embodiments of the present disclosure further provide a data processing method for a multi-blockchain. The multi-blockchain includes a target chain and a target service subchain. A target chain network corresponding to the target chain is independent of a target service subnetwork corresponding to the target service subchain. The target service subnetwork is constructed by a target consensus node in the target chain network based on a target service requested by a service object. The method is performed by a verification node in the target service subnetwork, and the method includes: receiving height confirmation information corresponding to a target chain height of the target service subchain transmitted by the target consensus node, the height confirmation information being generated by the target consensus node based on a subchain control contract deployed on the target chain, the subchain control contract being configured for controlling the target service subchain, and the target chain height of the target service subchain being determined by the target consensus node based on chain height voting information of the management node for the target service subchain and the subchain control contract when the target consensus node determines the management node of the target chain as a target registered node based on the subchain control contract; and the subchain control contract including the target registered node performing identity registration for the target service subchain; and writing the target chain height corresponding to the height confirmation information into a subchain management contract on the target service subchain, and determining, based on the target chain height, the chain height obtained after execution of the target service requested by the service object.

The embodiments of the present disclosure further provide a data processing method for a multi-blockchain. The multi-blockchain includes a target chain and a target service subchain. A target chain network corresponding to the target chain is independent of a target service subnetwork corresponding to the target service subchain. The target service subnetwork is constructed by a target consensus node in the target chain network based on a target service requested by a service object. The method is performed by a management node of the target chain, and the method includes: obtaining chain height voting information generated when the management node performs voting on a chain height of the target service subchain, a subchain control contract configured for controlling the target service subchain being deployed on the target chain, the subchain control contract including a target registered node performing identity registration for the target service subchain; transmitting the chain height voting information to the target consensus node, to cause the target consensus node to determine, when determining the management node as the target registered node based on the subchain control contract, a target chain height of the target service subchain based on the chain height voting information and the subchain control contract, and generate, based on the subchain control contract, height confirmation information corresponding to the target chain height, the height confirmation information being configured to be transmitted to a verification node in the target service subnetwork, the verification node being configured to write the target chain height corresponding to the height confirmation information into a subchain management contract on the target service subchain, the subchain management contract is configured to instruct the verification node to determine, based on the target chain height, a chain height obtained after execution of the target service requested by the service object; and obtaining the target chain height from the subchain management contract, and performing voting on the target service subchain based on the target chain height.

The embodiments of the present disclosure further provide a data processing apparatus for a multi-blockchain. The multi-blockchain includes a target chain and a target service subchain. A target chain network corresponding to the target chain is independent of a target service subnetwork corresponding to the target service subchain. The target service subnetwork is constructed by a target consensus node in the target chain network based on a target service requested by a service object. The apparatus is run on the target consensus node, and the apparatus includes: an information obtaining module, configured to obtain chain height voting information of a management node associated with the target chain for the target service subchain, a subchain control contract configured for controlling the target service subchain being deployed on the target chain, the subchain control contract including a target registered node performing identity registration for the target service subchain; a height determining module, configured to determine a target chain height of the target service subchain based on the chain height voting information and the subchain control contract and in response to determining the management node as the target registered node based on the subchain control contract on the target chain; and an information transmitting module, configured to generate height confirmation information corresponding to the target chain height based on the subchain control contract, and transmit the height confirmation information to a verification node in the target service subnetwork, to cause the verification node to write the target chain height corresponding to the height confirmation information into a subchain management contract on the target service subchain. The subchain management contract is configured to instruct the verification node to determine, based on the target chain height, a chain height obtained after execution of the target service.

The embodiments of the present disclosure further provide a data processing apparatus for a multi-blockchain. The multi-blockchain includes a target chain and a target service subchain. A target chain network corresponding to the target chain is independent of a target service subnetwork corresponding to the target service subchain. The target service subnetwork is constructed by a target consensus node in the target chain network based on a target service requested by a service object. The apparatus is run on a verification node in the target service subnetwork, and the apparatus includes: an information receiving module, configured to receive height confirmation information corresponding to a target chain height of the target service subchain transmitted by the target consensus node, the height confirmation information being generated by the target consensus node based on a subchain control contract deployed on the target chain, the subchain control contract being configured for controlling the target service subchain, and the target chain height of the target service subchain being determined by the target consensus node based on chain height voting information of the management node for the target service subchain and the subchain control contract when the target consensus node determines the management node of the target chain as a target registered node based on the subchain control contract; and the subchain control contract including the target registered node performing identity registration for the target service subchain; and a height writing module, configured to write the target chain height corresponding to the height confirmation information into a subchain management contract on the target service subchain, and determining, based on the target chain height, the chain height obtained after execution of the target service.

The embodiments of the present disclosure further provide a data processing apparatus for a multi-blockchain. The multi-blockchain includes a target chain and a target service subchain. A target chain network corresponding to the target chain is independent of a target service subnetwork corresponding to the target service subchain. The target service subnetwork is constructed by a target consensus node in the target chain network based on a target service requested by a service object. The apparatus is run on a management node of the target chain, and the apparatus includes: a vote obtaining module, configured to obtain chain height voting information generated when the management node performs voting on a chain height of the target service subchain, a subchain control contract configured for controlling the target service subchain being deployed on the target chain, the subchain control contract including a target registered node performing identity registration for the target service subchain; a vote transmitting module, configured to transmit the chain height voting information to the target consensus node, to cause the target consensus node to determine, when determining the management node as the target registered node based on the subchain control contract, a target chain height of the target service subchain based on the chain height voting information and the subchain control contract, and generate, based on the subchain control contract, height confirmation information corresponding to the target chain height, the height confirmation information being configured to be transmitted to a verification node in the target service subnetwork, the verification node being configured to write the target chain height corresponding to the height confirmation information into a subchain management contract on the target service subchain, the subchain management contract being configured to instruct the verification node to determine, based on the target chain height, a chain height obtained after execution of the target service; and a height obtaining module, configured to obtain the target chain height from the subchain management contract, and perform voting on the target service subchain based on the target chain height.

The embodiments of the present disclosure further provide a computer device, including a processor and a memory. The processor is connected to the memory. The memory is configured to store a computer program. When executed by the processor, the computer program causes the computer device to perform the method provided in the embodiments of the present disclosure.

The embodiments of the present disclosure further provide a non-transitory computer-readable storage medium. The computer-readable storage medium has a computer program stored therein. The computer program is adapted to be loaded and executed by a processor, to cause a computer device including the processor to perform the method provided in the embodiments of the present disclosure.

The embodiments of the present disclosure have the following beneficial technical effects:

In this embodiment of the present disclosure, a multi-blockchain includes a target chain and a target service subchain. A target chain network corresponding to the target chain is independent of a target service subnetwork corresponding to the target service subchain. In addition, the target service subnetwork is constructed by a target consensus node in the target chain network based on a target service requested by a service object. The target consensus node may obtain chain height voting information of a management node of the target chain for the target service subchain. A subchain control contract configured for controlling the target service subchain is deployed on the target chain. In addition, the subchain control contract includes a target registered node performing identity registration for the target service subchain. When it is determined, based on the subchain control contract on the target chain, that the management node is a target registered node, a target chain height of the target service subchain may be determined based on the chain height voting information and the subchain control contract. Subsequently, the target consensus node may generate height confirmation information corresponding to the target chain height based on the subchain control contract, and transmit the height confirmation information to a verification node in the target service subnetwork. The verification node herein may be configured to write the target chain height corresponding to the height confirmation information into a subchain management contract on the target service subchain. The subchain management contract herein is configured to instruct the verification node to determine, based on the target chain height, a chain height obtained after execution of the target service requested by the service object.

In view of the above, for any service subchain (such as the foregoing target service subchain) created in a multi-blockchain architecture, a management node that needs to manage the service subchain may perform identity registration in a subchain control contract as a corresponding registered node (such as the foregoing target registered node). After performing the identity registration, the management node may obtain chain height voting information for the service subchain. When obtaining the corresponding chain height voting information, the target consensus node may calculate a currently confirmed chain height (such as the target chain height) of the service subchain from the chain height voting information based on the subchain control contract, and may transmit the confirmed chain height to a verification node in the corresponding service subnetwork (such as the target service subnetwork). The verification node writes the chain height into a subchain management contract, to determine a chain height obtained after subsequent execution of a related subchain service (such as the foregoing target service), thereby controlling and managing the subchain service. In other words, flexible management can be implemented on any service subchain in the multi-blockchain architecture based on the subchain control contract on the target chain. In addition, since both the target chain and the management node are independent of the service subchain, in a process of managing the service subchain, related subchain services can still be executed orderly on the service subchain, which does not affect independent operation of the service subchain.

### BRIEF DESCRIPTION OF THE DRAWINGS

FIG. 1 is a schematic diagram of a hierarchical structure of a blockchain network according to an embodiment of the present disclosure.

FIG. 2 is a schematic diagram of a scenario of a blockchain electronic bill platform based on a multi-blockchain according to an embodiment of the present disclosure.

FIG. 3 is a schematic diagram of interaction in a blockchain electronic bill scenario according to an embodiment of the present disclosure.

FIG. 4 is a schematic diagram of a scenario of managing a subchain service in a multi-blockchain architecture according to an embodiment of the present disclosure.

FIG. 5 is a schematic flowchart of a data processing method for a multi-blockchain according to an embodiment of the present disclosure.

FIG. 6 is a schematic flowchart of a data processing method for a multi-blockchain according to an embodiment of the present disclosure.

FIG. 7 is a schematic flowchart of a data processing method for a multi-blockchain according to an embodiment of the present disclosure.

FIG. 8 is a schematic interaction flowchart of a data processing method for a multi-blockchain according to an embodiment of the present disclosure.

FIG. 9 is a schematic structural diagram of a data processing apparatus for a multi-blockchain according to an embodiment of the present disclosure.

FIG. 10 is a schematic structural diagram of a data processing apparatus for a multi-blockchain according to an embodiment of the present disclosure.

FIG. 11 is a schematic structural diagram of a data processing apparatus for a multi-blockchain according to an embodiment of the present disclosure.

FIG. 12 is a schematic structural diagram of a computer device according to an embodiment of the present disclosure.

FIG. 13 is a schematic structural diagram of a data processing system for a multi-blockchain according to an embodiment of the present disclosure.

### DESCRIPTION OF EMBODIMENTS

The following clearly and completely describes the technical solutions in the embodiments of the present disclosure with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

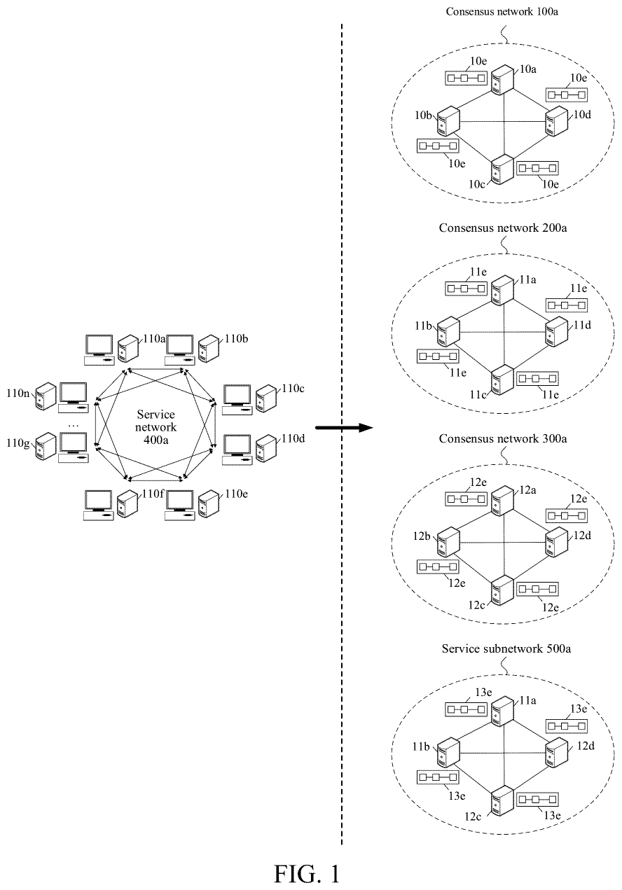

Referring to FIG. 1, FIG. 1 is a schematic diagram of a hierarchical structure of a blockchain network according to an embodiment of the present disclosure. The hierarchical structure shown in FIG. 1 may be applied to a blockchain system in a plurality of service scenarios. For example, the blockchain system may be a blockchain electronic bill system or a blockchain electronic document system. A blockchain network corresponding to the blockchain system may include a service network deployed in a public network and a plurality of consensus networks deployed in a private cloud. As shown in FIG. 1, the service network herein may be a service network 400a shown in FIG. 1, and the plurality of consensus networks herein may specifically include a consensus network 100a, a consensus network 200a, and a consensus network 300a shown in FIG. 1.

A plurality of service nodes may be deployed in the service network 400a shown in FIG. 1. The plurality of service nodes herein may include a service node 110a, a service node 110b, a service node 110c, a service node 110d, a service node 110e, a service node 110f, a service node 110g, . . . , and a service node 110n shown in FIG. 1. A quantity of service nodes deployed in the service network 400a is not limited herein. A service node located in the service network 400a does not need to participate in bookkeeping. In addition, as shown in FIG. 1, all service nodes running in the service network 400a may access one or more of the foregoing plurality of consensus networks in a network communication form. A quantity of consensus networks accessed by service objects through corresponding service nodes is not limited herein. The consensus networks may also exchange data with each other in the network communication form.

In the consensus network 100a shown in FIG. 1, a plurality of consensus nodes may be deployed. The plurality of consensus nodes herein may include a consensus node 10a, a consensus node 10b, a consensus node 10c, and a consensus node 10d shown in FIG. 1. A quantity of consensus nodes deployed in the consensus network 100a is not limited herein. In addition, as shown in FIG. 1, for the plurality of consensus nodes running in the consensus network 100a, a jointly maintained blockchain is a blockchain 10e shown in FIG. 1.

Similarly, in the consensus network 200a shown in FIG. 1, a plurality of consensus nodes may be deployed. The plurality of consensus nodes herein may include a consensus node 11a, a consensus node 11b, a consensus node 11c, and a consensus node 11d shown in FIG. 1. A quantity of consensus nodes deployed in the consensus network 200a is not limited herein. In addition, as shown in FIG. 1, for the plurality of consensus nodes running in the consensus network 200a, a jointly maintained blockchain is a blockchain 11e shown in FIG. 1.

By analogy, in the consensus network 300a shown in FIG. 1, a plurality of consensus nodes may be deployed. The plurality of consensus nodes herein may include a consensus node 12a, a consensus node 12b, a consensus node 12c, and a consensus node 12d shown in FIG. 1. A quantity of consensus nodes deployed in the consensus network 300a is not limited herein. In addition, as shown in FIG. 1, for the plurality of consensus nodes running in the consensus network 300a, a jointly maintained blockchain is a blockchain 12e shown in FIG. 1.

For ease of understanding, in the embodiments of the present disclosure, the service nodes and the consensus nodes in the foregoing blockchain system may be collectively referred to as blockchain nodes (nodes for short), the consensus network 100a, the consensus network 200a, and the consensus network 300a that participate in forming the foregoing blockchain system may be collectively referred to as core consensus networks, and nodes in the foregoing core consensus networks may be collectively referred to as core nodes.

In the embodiments of the present disclosure, network isolation may be performed on the service networks and the core consensus networks through a routing network (not shown in FIG. 1). For example, through a routing node in the routing network, network layering may be performed on a peer-to-peer (P2P) network to form a hierarchical structure such as a “service network—core consensus network”, which can improve the confidentiality and security of data on a blockchain. There may be one or more routing nodes in the routing network, which is not limited herein.

The blockchain involved in the embodiments of the present disclosure is a novel application mode of computer technologies such as distributed data storage, P2P transmission, a consensus mechanism, and an encryption algorithm, and is mainly configured to organize data in chronological order and encrypt the data into a ledger, to perform verification on, store, and update the data while preventing the data from being tampered with or forged. The blockchain is essentially a decenteralized database. Every node in the database stores a same blockchain.

For example, a blockchain stored on every node (for example, core nodes such as the consensus node 10a, the consensus node 10b, the consensus node 10c, and the consensus node 10d) in the consensus network 100a is the blockchain 10e. The blockchain 10e herein may be a target chain in the foregoing blockchain system (for example, may be a management chain in a blockchain electronic bill system or may be a management chain in a blockchain electronic document system). In addition, a core consensus network (that is, the consensus network 100a) corresponding to the target chain may be a target chain network (for example, may be a management chain network corresponding to the management chain). The consensus nodes (or the core nodes) in the target chain network may be collectively referred to as target consensus nodes (for example, may be management consensus nodes in the management chain network). In another example, a blockchain stored on every node (for example, core nodes such as the consensus node 11a, the consensus node 11b, the consensus node 11c, and the consensus node 11d) in the consensus network 200a is the blockchain 11e. The blockchain 11e herein may be a first chain in the foregoing blockchain system (for example, may be a bill chain in a blockchain electronic bill system or may be a document chain in a blockchain electronic document system). In addition, a core consensus network (that is, the consensus network 200a) corresponding to the first chain may be a first chain network (for example, may be a bill chain network corresponding to the bill chain or a document chain network corresponding to the document chain). The consensus nodes (or the core nodes) in the first chain network may be collectively referred to as first consensus nodes (for example, may be bill consensus nodes in the bill chain network or document consensus nodes in the document chain network). In another example, a blockchain stored on every node (for example, core nodes such as the consensus node 12a, the consensus node 12b, the consensus node 12c, and the consensus node 12d) in the consensus network 300a is the blockchain 12e. The blockchain 12e herein may be a second chain in the foregoing blockchain system (for example, may be an application contract chain in a blockchain electronic bill system or may be an application contract chain in a blockchain electronic document system). In addition, a core consensus network (that is, the consensus network 300a) corresponding to the second chain may be a second chain network (for example, may be an application contract chain network corresponding to the application contract chain). The consensus nodes (or the core nodes) in the second chain network may be collectively referred to as second consensus nodes (for example, may be application consensus nodes in the application contract chain network).

In the foregoing blockchain system, a core node may be responsible for consensus in a core consensus network on which a corresponding blockchain is located. That is, the core node may be a consensus node of a core consensus network on which a corresponding blockchain is located. For any core consensus network in the foregoing three core consensus networks, a process of writing transaction data in the core consensus network into a corresponding blockchain ledger (for example, a distributed database) may be that: A user client transmits the transaction data to a specific service node. Then, the transaction data is transferred as a baton between service nodes in a service network in the blockchain network until a consensus node (for example, the consensus node 11b in the consensus network 200a) in a corresponding core consensus network in the foregoing blockchain network receives the transaction data. In this case, the consensus node (for example, the consensus node 11b in the consensus network 200a) further packages the transaction data into a block, to facilitate subsequent consensus with another consensus node, so that after the consensus is reached, the consensus node may write the block reaching the consensus into a distributed database of a core consensus network (for example, the consensus network 200a) in which the consensus node is located.

In some embodiments, alternatively, in the embodiments of the present disclosure, after the consensus is reached, the consensus node may write, through a storage layer of a core consensus network (for example, the consensus network 200a) in which the consensus node is located, a block carrying the transaction data and a plurality of other blocks associated with the block into the distributed database, so that limitations of the blockchain structure of the blockchain can be broken through from the root, which can effectively improve the storage efficiency of data storage.

In the foregoing blockchain system, a smart contract may be deployed on a blockchain of a corresponding core consensus network. The smart contract in a blockchain system may be understood as code executed by blockchain nodes (that is, consensus nodes). Any logic can be executed based on the smart contract, and a result can be obtained. For example, a user may invoke, in a manner of initiating a transaction service request through a user client, a smart contract that has been deployed on a blockchain (for example, the foregoing blockchain 11e) of a corresponding core consensus network (for example, the foregoing consensus network 200a).

For example, a service node in a service network may transmit the transaction service request to a consensus node (for example, the consensus node 11a shown in FIG. 1) in the corresponding core consensus network, to perform, through a chain entrance of the corresponding core consensus network, identity authentication on the user transmitting the transaction service request, and allow, when the identity authentication succeeds, to transmit the transaction service request transmitted by the user to another consensus node (for example, the consensus node 11b shown in FIG. 1) in the corresponding core consensus network, to invoke smart contracts run in the consensus nodes (for example, the consensus node 11a and the consensus node 11b shown in FIG. 1) to execute a transaction service requested by the user. In a service scenario related to a blockchain electronic bill, the transaction service herein may include a bill service and a bill derivative service associated with the bill service. In a service scenario related to a blockchain electronic document, the transaction service herein may include a document service and a document derivative service associated with the document service.

One or more smart contracts may be deployed on the blockchain (for example, the foregoing blockchain 11e) of the foregoing core consensus network (for example, the foregoing consensus network 200a). The smart contracts may be distinguished by contract invocation addresses, contract identification numbers (identity documents, IDs), or contract names. Moreover, the transaction service request initiated by the user client may also carry a contract invocation address, a contract identification number, or a contract name of a smart contract, to specify the smart contract that needs to be run. However, in the foregoing blockchain system, if the smart contract specified by the user client is a smart contract requiring to read data across chains (that is, a cross-chain reading contract), the consensus nodes request, based on a chain identifier specified by the cross-chain reading contract, to read data from a corresponding blockchain. Finally, the consensus nodes may mutually verify whether transaction execution results obtained after transactions are executed based on information read across chains are consistent (that is, consensus is performed), store the transaction execution results in respective local caches and local storages if the transaction execution results are consistent, and return the transaction execution results of the transaction service to the user client. The local cache herein is a system memory created in the storage layer, and the local storage herein is a hard drive space created in the storage layer for data storage. In this way, in a case that a specific consensus node in the core consensus network is down (that is, down) or has a system failure, a phenomenon that data cannot be read because the data in the system memory disappears may not occur, that is, the consensus node may also read the data through the local storage created in the storage layer.

In the foregoing blockchain system, a P2P network may be formed between any two blockchain nodes in any consensus network (for example, the consensus network 100a, the consensus network 200a, or the consensus network 300a). The P2P network may use a P2P protocol. The P2P protocol is an application layer protocol run over a transmission control protocol (TCP) protocol. Any device, such as a server or a terminal, may be added to a distributed system to become a blockchain node. Each blockchain node may include a hardware layer, an intermediate layer, an operating system layer, and an application layer.

In the embodiments of the present disclosure, for any role (for example, an entity object such as any personal user, any enterprise, or any institution) accessing the blockchain network, a blockchain node may be configured through the target consensus node in the target chain network. Therefore, in the service network 400a shown in FIG. 1, the service node 110a, the service node 110b, the service node 110c, the service node 110d, . . . , and the service node 110n may respectively have a one-to-one correspondence with corresponding roles requiring to access the blockchain network.

When the consensus network 100a is used as the foregoing target chain network, a consensus node (for example, the foregoing target consensus node, where the target consensus node may be the consensus node 10a shown in FIG. 1) located in the target chain network may provide a registration service and an authorization service for a corresponding role (or a corresponding object) accessing the target chain network through a target chain network entrance, thereby performing identity management and authority management in the target chain network on the corresponding role (that is, the corresponding object) needing to access the blockchain network (for example, the target chain network, the first chain network, or the second chain network). In addition, the target consensus nodes located in the target chain network may be further configured to perform data management on relevant metadata information in the blockchain system. For example, in the blockchain electronic bill system, a management consensus node in a management chain network of the blockchain electronic bill system may manage and update a contract template on the management chain (the contract template on the management chain may include a management contract template of a smart contract deployed on the management chain and an application contract template of a smart contract deployed on the application contract chain), a bill template recorded on the management chain, a tax calculation rule associated with the bill template, and the like, and control access traffic at a chain entrance corresponding to the bill chain, a quantity of consensus nodes on chains participating in consensus reaching, and the like. In another example, in the blockchain electronic document system, a management consensus node in a management chain network of the blockchain electronic document system may manage and update a document template recorded on the management chain, as well as an issuance rule, a verification rule, and the like associated with the document template, and control access traffic at a chain entrance corresponding to the document chain, a quantity of consensus nodes on chains participating in consensus reaching, and the like.

For example, when needing to deploy a smart contract corresponding to a specific derivative service (for example, a bill derivative service or a document derivative service) on the application contract chain, in a case of accessing the application contract chain network through the chain entrance (that is, the application contract chain entrance) corresponding to the application contract chain, a developer and a service participant may read an application contract template corresponding to the derivative service from the management chain across chains, to deploy the smart contract corresponding to the derivative service on the application contract chain based on the read application contract template. In this way, when needing to execute the derivative service on the application contract chain subsequently, the service participant may execute the corresponding derivative service by using the deployed smart contract corresponding to the derivative service.

When the foregoing consensus network 200a is used as a bill chain network in the foregoing blockchain electronic bill system, a consensus node (for example, the foregoing bill consensus node, where the bill consensus node may be the consensus node 11b shown in FIG. 1) located in the bill chain network may be configured to provide a bill service. The bill service herein may include, but is not limited to, electronic bill-related services such as an electronic bill issuance service, an electronic bill circulation service, an electronic bill red-ink offset service, and an electronic bill archiving service. In some embodiments, when the foregoing consensus network 200a is used as a document chain network in the foregoing blockchain electronic document system, a consensus node (for example, the foregoing document consensus node, where the document consensus node may be the consensus node 11b shown in FIG. 1) located in the document chain network may be configured to provide a document service. The document service herein may include, but is not limited to, electronic document-related services such as an electronic document issuance service, an electronic document circulation service, an electronic document amendment service, and an electronic document archiving service. The electronic document may include, but is not limited to, electronic documents in various forms such as an electronic contract, an electronic official document, an electronic prescription, and an electronic certificate.

In addition, when the consensus network 300a is used as the application contract chain network in the foregoing blockchain electronic bill system, a consensus node (for example, the foregoing application consensus node, where the application consensus node may be the consensus node 12b shown in FIG. 1) located in the application contract chain network may be configured to provide a bill derivative service (for example, a crediting service, an entry and exit loss service, an enterprise qualification service, a credit investigation service, a social service, a credit purchase service, a tax refund service, or a lottery service) associated with the bill service. In some embodiments, when the consensus network 300a is used as the application contract chain network in the foregoing blockchain electronic document system, a consensus node (for example, the foregoing application consensus node, where the application consensus node may be the consensus node 12b shown in FIG. 1) located in the application contract chain network may be configured to provide a document derivative service (for example, an institutional cooperation service, an enterprise qualification service, a prescription statistics service, a qualification review services, or a management service) associated with the document service.

Because each entity object may correspond to one blockchain node, in the embodiments of the present disclosure, using an example in which the entity object is the foregoing enterprise user (that is, the foregoing enterprise), blockchain nodes associated with each enterprise user may be the same blockchain node (for example, the service node 110c shown in FIG. 1 may exchange data with user terminals corresponding to a plurality of enterprise users). For example, in the foregoing blockchain electronic bill system, a bill service (for example, an electronic bill-related service such as an electronic bill issuance service, an electronic bill circulation service, an electronic bill red-ink offset service, and an electronic bill archiving service) requested by each enterprise user may be collectively referred to as a transaction service. When being a bill issuance enterprise A requesting bill issuance through a bill chain network (for example, the consensus network 200a), the enterprise user may exchange data with a consensus node (for example, the consensus node 11b) in the consensus network 200a through the service node 110c shown in FIG. 1, to request completion of a corresponding transaction. Similarly, a bill issuance enterprise B may exchange data with a consensus node (for example, the consensus node 11b) in the consensus network 200a through the service node 110c shown in FIG. 1, to request completion of a corresponding transaction. By analogy, a bill issuance enterprise C may exchange data with a consensus node (for example, the consensus node 11b) in the consensus network 200a through the service node 110c shown in FIG. 1, to request completion of a corresponding transaction.

For case of understanding, in the embodiments of the present disclosure, using an example in which the transaction service is a bill service (for example, an electronic bill issuance service), when receiving a transaction service request associated with a transaction service, a service node associated with a specific entity object (for example, the bill issuance enterprise A) may forward the transaction service request initiated by the entity object to a specific bill consensus node in a bill chain network (for example, the consensus network 200a), for performing, through the bill consensus node, validity verification on the transaction service request initiated by the entity object. In this way, the bill consensus node may add the transaction service (for example, the foregoing bill service) requested by the entity object to a transaction pool when the validity verification succeeds, to facilitate subsequently packaging transaction data associated with the transaction service (for example, the foregoing bill service) into a block, for performing block consensus among consensus nodes in the consensus network 200a. Therefore, block data of the block can be written to a local cache and a local storage after the block consensus is reached, to facilitate subsequent parallel storage of block data of a plurality of blocks based on the foregoing distributed storage.

In some special service scenarios, the three-chain architecture-based blockchain network described above cannot fully meet requirements of service forms either. For example, if some local services that generate a large amount of temporary data and unimportant data, or some dedicated services or special services configured to process specific data are all run centrally on a same blockchain (for example, an application contract chain), the blockchain is burdened. Based on this, the embodiments of the present disclosure can support a user to create one or more service subnetworks in a blockchain multi-chain architecture. A quantity of the service subnetworks is not limited herein. Using an example in which the multi-chain architecture is the foregoing three-chain architecture, a service subchain independent of the target chain, the first chain, and the second chain can be established in the core consensus network based on a related subnetwork protocol. As shown in FIG. 1, the service subnetwork herein may be a service subnetwork 500a shown in FIG. 1. The service subnetwork 500a may be a network instantly constructed based on a requirement of a dedicated service or a special service in a case that the three existing consensus networks (namely, the consensus network 100a, the consensus network 200a, and the consensus network 300a) cannot fully meet a service requirement. Data extraction and destruction may also be performed after service execution is completed.

Similar to the foregoing consensus network, in the service subnetwork 500a shown in FIG. 1, a plurality of consensus nodes may be deployed. A quantity of consensus nodes deployed in the service subnetwork 500a is not limited herein. The service subnetwork 500a may perform fast node construction by reusing a plurality of consensus nodes in the existing consensus networks (for example, the consensus network 200a and the consensus network 300a). For example, as shown in FIG. 1, the plurality of consensus nodes herein may include the consensus node 11a and the consensus node 11b in the consensus network 200a, and the consensus node 12c and the consensus node 12d in the consensus network 300a. In addition, as shown in FIG. 1, for the plurality of consensus nodes running in the service subnetwork 500a, a jointly maintained blockchain is a blockchain 13e shown in FIG. 1. The blockchain 13e is a blockchain different from the blockchain 10c, the blockchain 11e, and the blockchain 12c.

A blockchain stored on every node (for example, core nodes such as the consensus node 11a, the consensus node 11b, the consensus node 12c, and the consensus node 12d) in the service subnetwork 500a is the blockchain 13e. The blockchain 13e herein may be a service subchain in the foregoing blockchain system (for example, may be a service subchain in a blockchain electronic bill system or may be a service subchain in a blockchain electronic document system). In addition, a service subnetwork (that is, the service subnetwork 500a) corresponding to the service subchain may be a service subnetwork created when obtaining authorization from the target chain. The consensus nodes (or the core nodes) in the service subnetwork may be collectively referred to as verification nodes. In addition, the verification nodes herein may originate from the first consensus node (for example, the bill consensus node in the bill chain network) in the first chain network and the second consensus node (for example, the application consensus node in the application contract chain network) in the second chain network. For ease of distinction, in the embodiments of the present disclosure, the consensus nodes obtained from the first chain network may be collectively referred to as first verification nodes. Similarly, the consensus nodes obtained from the second chain network may be collectively referred to as second verification nodes.

In the foregoing blockchain system, the verification node may be responsible for consensus in the service subnetwork on which the corresponding service subchain is located. In other words, the verification node may be a consensus node in the service subnetwork on which the corresponding service subchain is located. The service subnetwork may be understood as a core consensus network that a specific entity object in the blockchain system applies to create. Therefore, for content related to the service subnetwork, reference may be made to the foregoing related descriptions of the core consensus network. For example, with regard to a service subnetwork, for a process of writing transaction data in the service subnetwork into a corresponding blockchain ledger (for example, a distributed database), reference may be made to the foregoing described process of writing transaction data in the core consensus network into a corresponding blockchain ledger. Details are not described herein again.

Similarly, in the embodiments of the present disclosure, one or more smart contracts may be deployed on a service subchain (for example, the blockchain 13e) of the service subnetwork (for example, the service subnetwork 500a), so that when obtaining a transaction service request transmitted by a specific entity object, a verification node in the service subnetwork may invoke a deployed smart contract to execute a transaction service requested by the entity object. For ease of understanding and description, in the embodiments of the present disclosure, transaction services (which may also be referred to as temporary services) executed by the verification nodes in the service subnetwork may be collectively referred to as subchain services. The subchain services may be local services that generate a large amount of temporary data and unimportant data, or may be dedicated services dedicated to processing a specific type of transactions, or other special services. For example, in a service scenario related to a blockchain electronic bill, the subchain service herein may be a temporary service (which may also be referred to as a bill temporary service) associated with the foregoing bill service or bill derivative service. In a service scenario related to a blockchain electronic document, the subchain service herein may be a temporary service (which may also be referred to as a document temporary service) associated with the foregoing document service or document derivative service. In addition, in the embodiments of the present disclosure, entity objects (for example, a personal user, an enterprise user, an institution, and the like) that apply to create a service subnetwork to execute a subchain service may be collectively referred to as service objects.

A consensus node (for example, the foregoing target consensus node, where the target consensus node may be the consensus node 10a shown in FIG. 1) located in the foregoing target chain network may perform identity management and authority management in the target chain network on a corresponding role (that is, a corresponding object) requiring to access a service subnetwork. In addition, the target consensus node located in the target chain network may be further configured to perform data management on metadata information associated with the service subnetwork. For example, a management consensus node in a management chain network of a blockchain electronic bill system may manage and update a contract template (for example, a subchain contract template of a smart contract deployed on the service subchain) that is on a management chain and that is associated with the service subchain.

For example, when needing to deploy a smart contract corresponding to a specific subchain service (for example, a bill temporary service or a document temporary service) on the service subchain, in a case of obtaining authorization from the management chain to access the service subnetwork, a developer and a service participant may read a subchain contract template corresponding to the subchain service from the management chain across chains, to deploy the smart contract corresponding to the subchain service on the service subchain based on the read subchain contract template. In this way, when needing to execute the subchain service on the service subchain subsequently, the service participant may execute the corresponding subchain service by using the deployed smart contract corresponding to the subchain service.

In addition, when the service subnetwork 500a is used as a service subnetwork in the foregoing blockchain electronic bill system, a verification node (for example, the verification node may be the consensus node 11a shown in FIG. 1) located in the service subnetwork may be configured to provide a temporary service (for example, a bill statistics service, a taxation audit service, a credit review service, an entry and exit loss analysis service, an enterprise qualification comparison service, a credit analysis service, a social service, a credit purchase analysis service, a tax refund review service, or a lottery winning check service) associated with the bill service or bill derivative service. In some embodiments, when the service subnetwork 500a is used as a service subnetwork in the foregoing blockchain electronic document system, a verification node (for example, the verification node may be the consensus node 11a shown in FIG. 1) located in the service subnetwork may be configured to provide a temporary derivative service (for example, a cooperation risk prediction service, an enterprise qualification review service, a drug procurement service based on a prescription statistics result, a qualification certification incentive service, or a document sensitive information detection service) associated with the document service or document derivative service. In addition, after the verification node executes the relevant temporary service, an obtained temporary service execution result may be written into the service subchain.

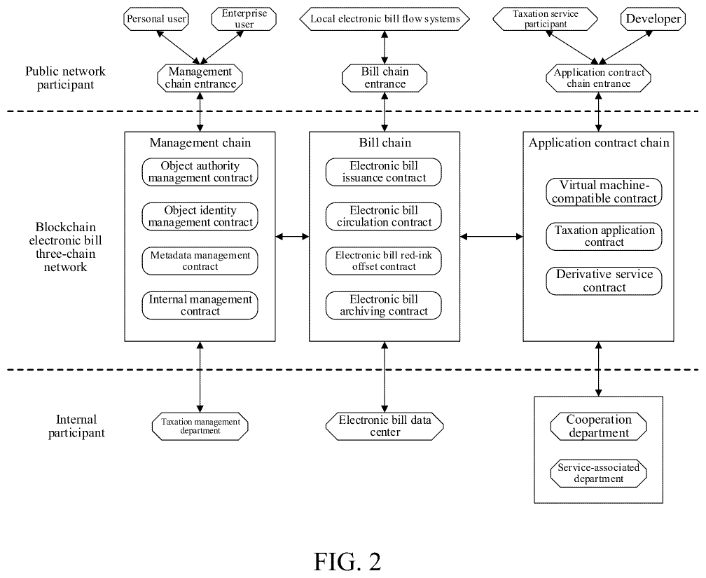

For case of understanding, referring to FIG. 2, FIG. 2 is a schematic diagram of a scenario of a blockchain electronic bill platform based on a multi-blockchain according to an embodiment of the present disclosure. The blockchain electronic bill platform may be a service platform in the foregoing blockchain electronic bill system. In the blockchain electronic bill platform, to lower the hybridity of data storage on the chain, a multi-chain system based on a blockchain electronic bill is provided, and the multi-chain system mainly involves a blockchain electronic bill three-chain network shown in FIG. 2. As shown in FIG. 2, a management chain (that is, the foregoing target chain), a bill chain (that is, the foregoing first chain), and an application contract chain (that is, the foregoing second chain) are deployed in the blockchain electronic bill three-chain network. In a service scenario in which a blockchain is circulated as blockchain electronic bill core data, functional characteristics independently executing different services may be provided for the entire blockchain electronic bill platform through mutual cooperation between the management chain, the bill chain, and the application contract chain, so that a secure and efficient service flow system can be constructed on the premise of the mutual cooperation between the three chains. Using an example in which the multi-chain system is a three-chain system, in the three-chain system, the management chain, the bill chain, and the application contract chain are all independently built. To be specific, a consensus node configured to maintain the management chain is different from a consensus node configured to maintain the bill chain, and is also different from a consensus node configured to maintain the application contract chain.

As shown in FIG. 2, the management chain deployed in the blockchain electronic bill three-chain network is independent of the bill chain and the application contract chain. That is, the three blockchains that are independently built are independent of each other. However, the three blockchains that are independently built may exchange data across chains. That is, cross-chain interaction may be performed between the three chains. For example, a consensus node (that is, the foregoing second consensus node) participating in maintaining the application contract chain shown in FIG. 2 may execute a corresponding bill derivative service by reading core data (for example, bill information in an electronic bill on the bill chain) on the bill chain across chains (for example, may execute the foregoing credit investigation service based on bill information read from the bill chain, to obtain enterprise credit investigation information of a specific enterprise).

For example, the management chain herein may be configured to provide a management functional characteristic for the entire blockchain electronic bill platform. The bill chain herein may provide functional characteristics of bill services with different service authority types for the entire blockchain electronic bill platform. In the embodiments of the present disclosure, to ensure security and independence of an electronic bill written into the bill chain, the embodiments of the present disclosure propose that bill derivative services that are more standardized, flexible, and functionally complete may be provided through another blockchain (that is, the application contract chain shown in FIG. 2) independent of the management chain and the bill chain. That is, the application contract chain herein may provide, for the entire blockchain electronic bill platform, a functional characteristic of carrying out a bill derivative service based on core data in an electronic bill.

For case of understanding, using an example in which a core consensus network (that is, the foregoing management chain network) on which the management chain is located is the consensus network 100a shown in FIG. 1, a consensus node participating in maintaining the management chain may be the foregoing management consensus node. As shown in FIG. 2, a plurality of smart contracts are deployed on the management chain. The smart contracts may be run on the management consensus node. The plurality of smart contracts herein may include an object authority management contract, an object identity management contract, a metadata management contract, and an internal management contract shown in FIG. 2. The smart contracts deployed on the management chain are determined by internal participants (that is, a taxation management department) shown in FIG. 2 respectively based on corresponding management contract templates deployed on their chains (that is, the management chain).

The foregoing taxation management department may exercise management responsibilities through the management consensus node deployed in the management chain network. For example, the management responsibilities herein may include managing internal information of a management department (for example, information about internal personnel of the taxation management department), managing a service logic rule for an overall service (for example, a derivative service contract run on the application contract chain for executing service logic of a derivative service), managing metadata information (for example, access traffic at chain entrances in the three-chain system) of the overall service, performing identity management and authority management on a participant (for example, an entity object such as a personal user, an enterprise user, or a taxation service participant) of the overall service, and so on. In the blockchain network corresponding to the overall service, the management chain maintained by the management consensus node is a blockchain that is stabler and has a smallest data scale, but has highest security.

In addition, for ease of understanding, using an example in which a core consensus network (that is, the foregoing bill chain network) on which the bill chain shown in FIG. 2 is located is the consensus network 200a shown in FIG. 1, a consensus node participating in maintaining the bill chain may be the foregoing first consensus node (which may also be referred to as a bill consensus node herein). As shown in FIG. 2, a plurality of smart contracts are deployed on the bill chain. The smart contracts may be run on the first consensus node. The plurality of smart contracts herein may include an electronic bill issuance contract, an electronic bill circulation contract, an electronic bill red-ink offset contract, and an electronic bill archiving contract shown in FIG. 2. Similarly, the smart contracts deployed on the bill chain are determined by an internal participant (for example, a taxation department associated with an electronic bill data center) shown in FIG. 2 based on a corresponding bill service contract template deployed on the management chain.

A first consensus node deployed in the bill chain network may maintain service logic of an electronic bill in a full life cycle through the bill chain, for example, may manage, through the bill chain, full life cycles of all issued electronic bills. For example, a full life cycle of an electronic bill herein includes issuance of the electronic bill, circulation of the electronic bill, reimbursement of the electronic bill, and the like. In the blockchain network corresponding to the overall service, the bill chain maintained by the first consensus node features high performance and low latency.

Likewise, for case of understanding, using an example in which a core consensus network (that is, the foregoing application contract chain network) on which the application contract chain is located is the consensus network 300a shown in FIG. 1, a consensus node participating in maintaining the application contract chain may be the foregoing second consensus node (which may also be referred to as an application consensus node herein). As shown in FIG. 2, a plurality of smart contracts are deployed on the application contract chain. The smart contracts may be run on the second consensus node. The plurality of smart contracts herein may include a virtual machine-compatible contract, an open contract deployment contract, and a derivative service contract shown in FIG. 2.

A second consensus node deployed in the application contract chain network may bear, through the application contract chain, a bill derivative service corresponding to a changeable bill service. For example, the bill derivative service herein may include the foregoing credit investigation service, the foregoing qualification identification service, and the like. In the blockchain network corresponding to the overall service, the application contract chain maintained by the second consensus node may support a cooperation department and a consortium chain partner (that is, a service-associated department shown in shown in FIG. 2) shown in FIG. 2, to use an application contract template read from the management chain across chains to develop a smart contract (for example, the derivative service contract shown in FIG. 2) related to the bill derivative service. In addition, the derivative service contract may be deployed on the application contract chain after being reviewed by the taxation management department. The smart contracts deployed on the application contract chain may be flexibly upgraded and changed based on a virtual machine-compatible contract. In the blockchain network corresponding to the overall service, the second consensus node may implement cross-chain interaction, for example, may read the foregoing core data from the bill chain to execute a derivative service. It means that the application contract chain maintained by the first consensus node has the highest openness compared with the management chain and the bill chain, supports complex smart contract logic, has a large number of participants, changes constantly dynamically, and has performance lower than that of the bill chain.

In the blockchain electronic bill three-chain network shown in FIG. 2, a consensus algorithm used by the management chain is different from a consensus algorithm used by the bill chain and is also different from a consensus algorithm used by the application contract chain.

For example, (1.1) a consensus algorithm associated with the management chain is an instant deterministic consensus algorithm. For example, the instant deterministic consensus algorithm herein may be a practical Byzantine fault tolerance (PBFT) consensus algorithm. A state of a specific to-be-chained proposal block may be immediately determined based on the PBFT consensus algorithm. The management chain is a blockchain in the foregoing management chain network. In a consensus node (that is, the foregoing management consensus node) in the management chain network, a taxation management department shown in FIG. 2 may participate in management.

An internal participant associated with the management chain may be the taxation management department shown in FIG. 2. For example, when the taxation management department accesses the management chain as an internal participant, some internal states of the taxation management department may be managed based on an internal management contract on the management chain. For example, personnel in the taxation management department can be managed. For example, specific taxation management personnel, taxation development personnel, taxation audit personnel, and the like may be configured in the personnel of the taxation management department. In addition, when the taxation management department accesses the management chain as an internal participant, some parameters in the three-chain system may also be managed based on the internal management contract on the management chain. For example, an access traffic parameter corresponding to access traffic at the bill chain entrance shown in FIG. 2 may be limited based on the internal management contract. For example, access traffic at the bill chain entrance within some specific time periods may be controlled not greater than an access traffic threshold based on a time-sharing access mechanism. In another example, when the taxation management department accesses the management chain as an internal participant, a node count parameter corresponding to a quantity of consensus nodes on chains participating in consensus reaching may be limited based on the internal management contract on the management chain.

(1.2) A consensus algorithm associated with the bill chain is another instant deterministic consensus algorithm. For example, the instant deterministic consensus algorithm herein may be a tower Byzantine fault tolerance (TBFT) consensus algorithm. The TBFT consensus algorithm is a Byzantine fault tolerance algorithm that can guarantee secure running of the entire bill chain network system in a case that a quantity of Byzantine nodes (that is, a quantity of evil nodes in the bill chain network) is less than ⅓ of a total quantity of nodes in the bill chain network. The foregoing taxation management department may participate in management on a consensus node located in the bill chain network. For example, specific taxation personnel in the taxation management department may control a quantity of consensus nodes in the bill chain network based on an internal management contract in the foregoing management chain. In another example, a taxation bureau terminal corresponding to specific taxation personnel in the taxation management department may participate in forming the bill chain network.

A biggest difference between the foregoing TBFT consensus algorithm and the PBFT consensus algorithm is that: In the PBFT consensus algorithm, there is a fixed leader node (that is, a primary node) configured to package a transaction in a transaction pool, and when the leader node fails, the leader node is replaced by using a view-change sub-protocol (that is, a primary node switching sub-protocol). However, in the TBFT consensus algorithm, the leader node is rotated based on a rotation mechanism. For example, when a current node is used as the leader node, each time X blocks are submitted (a value of X can be configured), the leader node is automatically rotated to a next node. This means that the consensus nodes in the bill chain network corresponding to the bill chain may be configured to continuously produce blocks.

(1.3) A consensus algorithm associated with the application contract chain is another instant deterministic consensus algorithm. For example, the instant deterministic consensus algorithm herein may be a proof-of-stake (POS) consensus algorithm. Network security of the application contract chain network on which the application contract chain is located can be maintained based on the POS consensus algorithm. In addition, a state of a specific to-be-chained proposal block can be determined immediately based on the POS consensus algorithm. The taxation management department and the cooperation department shown in FIG. 2, a large-scale participant institution (that is, a large-scale enterprise in the foregoing consortium chain, where the large-scale enterprise is the service-associated department shown in FIG. 2), and the like jointly participate in management on the consensus node in the application contract chain network. For example, taxation personnel in the taxation management department (for example, a taxation service participant shown in FIG. 2) may read, across chains through a consensus node in the application contract chain network, bill information of an electronic bill written onto the foregoing bill chain, to execute a bill derivative service associated with the foregoing bill service based on the bill information read across chains. For example, qualification identification or credit investigation identification may be performed, based on bill information read across chains, on a bill issuance enterprise requesting bill issuance, to obtain qualification data or credit investigation data of the bill issuance enterprise. As shown in FIG. 2, when accessing the application contract chain network through the application contract chain entrance shown in FIG. 2, a taxation service participant herein may read, from the bill chain shown in FIG. 2, core data in an electronic bill requested based on a bill derivative service, to use the read core data to carry out the corresponding bill derivative service on the application contract chain.

In the embodiments of the present disclosure, there is no need to directly transfer a large number of electronic bills generated on the bill chain to the application contract chain across chains, and instead, partially-authorized-to-be-visible bill information (that is, the foregoing core data) in the electronic bills generated on the bill chain is transferred across chains to the application contract chain. In this way, privacy and security of the electronic bills recorded on the bill chain can be ensured from the root.

In view of the above, for the taxation service participant requesting to access the foregoing application contract chain, different core data (that is, bill information with different data content may be obtained from the foregoing electronic bills) may be read from the bill chain across chains according to different requested bill derivative services.

For the smart contracts in the blockchain electronic bill three-chain network, there are the following differences:

(2.1) A specific-language smart contract engine may be supported on the management chain shown in FIG. 2. The foregoing management consensus node may deploy a specific-language smart contract on the management chain through the specific-language smart contract engine. For example, an object authority management contract, an object identity management contract, a metadata management contract, and an internal management contract shown in FIG. 2 may be deployed on the management chain. The smart contracts can be developed and managed by specific taxation management personnel in the taxation management department.

(2.2) Smart contracts with specific bill service logic are built in the bill chain shown in FIG. 2. The smart contracts (for example, an electronic bill issuance contract, an electronic bill circulation contract, an electronic bill red-ink offset contract, and an electronic bill archiving contract shown in FIG. 2) may be upgraded with the update of the bill service. For example, in the embodiments of the present disclosure, the bill service logic in the electronic bill issuance contract may be updated based on metadata information read from the management chain, and further, the foregoing bill service may be updated and processed according to the updated electronic bill issuance contract. This means that the bill chain does not support an independent smart contract engine, and certainly, does not support deploying another contract irrelevant to the bill service on the bill chain. An advantage of this is that the bill chain only runs service logic related to the electronic bill, and is not affected by another smart contract, so that running of the bill chain is more independent and stable and more attack-resistant.

(2.3) The application contract chain supports a multi-language, Turing-complete, developer-oriented smart contract. For example, as shown in FIG. 2, when a developer accesses the application contract chain through an application contract chain entrance, compatibility with a mainstream EVM virtual machine may be reached based on a virtual machine-compatible contract, so that various new service contracts can be deployed on the virtual machine with which compatibility is reached. For example, a derivative service contract associated with a bill derivative service (for example, the foregoing lottery service) may be deployed on the application contract chain. In another example, a derivative application contract associated with another bill derivative service (for example, the foregoing tax refund service) may be deployed on the application contract chain.

As shown in FIG. 2, in the blockchain electronic bill three-chain network, public network participants associated with the management chain may be a personal user and an enterprise user shown in FIG. 2. Likewise, as shown in FIG. 2, public network participants associated with the bill chain may be local electronic bill data flow systems shown in FIG. 2. The local electronic bill flow systems herein specifically include local electronic bill service issuance systems (for example, local taxation bureau systems), electronic bill issuance service providers, finance and taxation-related systems of large-scale enterprises, and the like. Likewise, as shown in FIG. 2, public network participants associated with the application contract chain may be a taxation service participant and a developer shown in FIG. 2.

For example, (3.1) a chain entrance associated with the management chain may be a management chain entrance shown in FIG. 2. When serving as public network participants, the personal user (for example, a user A) and the enterprise user (for example, an enterprise B) shown in FIG. 2 and the like may access the management chain through the management chain entrance, and may further perform services, such as identity registration and identity authorization, through the management chain. (3.2) A chain entrance associated with the bill chain may be a bill chain entrance shown in FIG. 2. When serving as public network participants, the local electronic bill data flow systems (for example, large-scale enterprise users) shown in FIG. 2 and the like may access the bill chain through the bill chain entrance, and may further perform an electronic bill issuance service, an electronic bill circulation service, an electronic bill red-ink offset service, and an electronic bill archiving service through the bill chain. (3.3) A chain entrance associated with the application contract chain may be an application contract chain entrance shown in FIG. 2. When serving as public network participants, the taxation service participant and developer shown in FIG. 2 may access the application contract chain through the application contract chain entrance, and may further deploy derivative service contracts on the application contract chain, to execute electronic bill-related bill derivative services based on the deployed derivative service contracts. The developer shown in FIG. 2 may also deploy, in a case of accessing the application contract chain, a derivative service contract corresponding to another bill derivative service (or an exploratory service) on the application contract chain. A quantity of derivative service contracts deployed on the application contract chain is not limited herein.

The management chain entrance shown in FIG. 2 may be a taxation management department entrance. Through the taxation management department entrance, identity identification and service guidance may be performed on individuals, legal persons, entities, and the like that need to access the management chain.

The bill chain entrance shown in FIG. 2 may be an electronic bill service entrance. Transaction service data (which may also be referred to as transaction data) of an electronic bill whose issuance is requested by a specific entity object (for example, a first entity object, where the first entity object may be the foregoing enterprise B) may be received through the electronic bill service entrance. In this way, when receiving transaction service data submitted by the enterprise B through the electronic bill service entrance, the first consensus node may further verify, through the electronic bill service entrance, whether an access identity and access authority of a data transmitter (that is, the enterprise B serving as a first entity object) of the transaction service data meet state requirements of an identity authority contract in the management chain. Therefore, when the verification succeeds, it may be determined that the enterprise B serving as the first entity object is an authorized object, and then, service authority of the enterprise B serving as an authorized object can be determined by reading the foregoing first service association information from the management chain across chains. Based on the first service association information, it may be determined whether the service authority of the enterprise B serving as an authorized object meets a state requirement of an object authority management contract in the management chain.

For example, the first consensus node may determine, through the electronic bill service entrance, whether an access identity and access authority of the data transmitter (that is, the enterprise B) meet contract state requirements of an object identity management contract and an internal management contract in the management chain, and then, may determine, when determining that the contract state requirements of the object identity management contract and the internal management contract in the management chain are met, that identity authentication has been completed on the data transmitter (that is, the enterprise B) needing to access the bill chain. In view of the above, registration data information of authorized objects synchronized from the management chain is stored in the bill chain entrance shown in FIG. 2. The registration data information herein may include, but is not limited to, object access identity registration information and object access authority registration information. For example, the object access identity information herein may be configured for identifying whether a first entity object (that is, the enterprise B) currently requesting to access the bill chain is an authorized object. The object access authority registration information herein includes a request cumulative threshold (for example, a maximum concurrent request cumulative count) configured by the management consensus node for the electronic bill service entrance of the bill chain based on the internal management contract. The first service association information may be configured to represent which bill service contracts on the bill chain the first entity object (that is, the enterprise B) serving as an authorized object has authority to access.

The application contract chain entrance shown in FIG. 2 may be a taxation derivative service entrance. A bill derivative service that a specific entity object (for example, the second entity object, where the second entity object may be the taxation service participant shown in FIG. 2) requests to participate in and that is associated with the bill service may be received through the taxation derivative service entrance. The taxation service participant and the developer shown in FIG. 2 may perform, through the application contract chain entrance, after obtaining a service participation permission credential of an authorized object issued by the taxation management department, verification on a service participation permission credential submitted by the second entity object (for example, the taxation service participant or the developer), and then, may allow, when the verification succeeds, the second entity object to access the application contract chain to execute a bill derivative service associated with the foregoing bill service on the application contract chain.

As shown in FIG. 2, an internal participant participating in maintaining the management chain may be the taxation management department shown in FIG. 2. The taxation management department herein is mainly configured to configure and manage an internal state parameter on the management chain, may also be configured to change and chain the foregoing metadata information (for example, taxation metadata) (for example, may update an electronic bill template and update a tax calculation rule), and may manage identities and authority of various service participants maintained on the management chain (for example, freeze an bill issuance qualification of an enterprise, and limit a bill issuance amount of an enterprise).

As shown in FIG. 2, an internal participant participating in maintaining the bill chain may be an electronic bill data center shown in FIG. 2. The electronic bill data center herein may be an electronic invoice data center. The electronic bill data center (for example, the electronic invoice data center) may be configured to perform off-chain backup, statistics, data analysis, a review, and the like on massive ledger data (for example, an electronic bill flow generated based on the real-time bill service flow, and the like) recorded on the bill chain. For example, through the electronic bill data center, a time-sharing bill issuance count may be counted, then, a risk bill (for example, a risk invoice) and a risk enterprise may be determined based on the counted time-sharing bill issuance count, and data analysis and the like may also be performed on relevant financial and economic data.

As shown in FIG. 2, an internal participant participating in maintaining the application contract chain may be the cooperation department and the service-associated department shown in FIG. 2. The internal participant, other than the taxation management department, participating in maintaining the application contract chain and another department (that is, the foregoing cooperation department) and another participant (that is, the foregoing service-associated department) in the system consortium chain can all execute a corresponding bill derivative service based on a derivative service contract on the application contract chain in a case of accessing the application contract chain. An advantage that the cooperation department and the service-associated department shown in FIG. 2, as taxation service participants, access the application contract chain is that the cooperation department and the service-associated department can flexibly run various expendable bill derivative service in a cycle of supporting a complete smart contract statement, to ensure the flexibility of service changes without directly accessing core data of electronic bills on the bill chain, thereby ensuring data privacy and core data security on the bill chain. This means that the second consensus node involved in the embodiments of the present disclosure may read partially-authorized-to-be-visible bill chain data for a current bill derivative service on the bill chain, for example, may read, from the bill chain, core data (the core data herein may be bill information in electronic bills involved in the foregoing electronic bill flow, and for a case in which the electronic bill is an electronic invoice, the bill chain data herein may be partially-authorized-to-be-visible invoice data) related to the current bill derivative service across chains, to ensure, based on the read core data, that a bill derivative service requested by the second entity object can be effectively carried out on the application contract chain.

Corresponding smart contracts may be built in all the chains in the blockchain electronic bill three-chain network shown in FIG. 2.

(4.1) For smart contracts built in the management chain, as shown in FIG. 2, an object identity management contract built in the management chain may be a user management contract. Identities of an accessing party (for example, the public network participant) and a participant (for example, the internal participant) in the three-chain system may be managed based on the user management contract. The accessing party and the participant herein may include taxation management personnel (administrators for short), a cooperation department, a local taxation bureau, a bill issuance service provider, a reimbursement service provider, a taxation review department, and the like. In addition, an object authority management contract built in the management chain may be an enterprise identity management contract. Service authority, taxation statuses, and the like of some enterprises may be managed based on the enterprise identity management contract. Similarly, a metadata management contract built in the management chain may be a taxation metadata management contract. Metadata information, such as taxation rules, may be managed based on the taxation metadata management contract. For example, contract modules, tax calculation logic, latest policy rules, and the like in the three-chain system may be centrally managed. By analogy, an internal management contract built in the management chain may be configured for managing some internal statuses of the taxation management department and managing some internal parameters on the chains in the three-chain system. For example, based on the internal management contract, an access traffic parameter at the foregoing bill chain entrance (for example, an electronic invoice service entrance) may be limited, and a consensus node count parameter in the three-chain system may be limited.

(4.2) For smart contracts built in the bill chain, as shown in FIG. 2, the smart contracts built in the bill chain may include a bill service contract associated with an electronic bill life cycle. The bill service contract herein may include an electronic bill issuance contract configured for providing an electronic bill issuance service shown in FIG. 2, an electronic bill circulation contract configured for providing an electronic bill circulation service, an electronic bill red-ink offset contract configured for providing an electronic bill red-ink offset service, and an electronic bill archiving contract configured for providing an electronic bill archiving service.

(4.3) For smart contracts built in the application contract chain, as shown in FIG. 2, the smart contracts built in the bill chain may include various contracts (for example, the virtual machine-compatible contract, the taxation application contract, the derivative service contract, and the like shown in FIG. 2) for which a taxation derivative service participant (that is, a derivative service object, for example, the taxation service participant shown in FIG. 2) participates in deployment. For example, the derivative service contract herein may be a credit investigation service contract based on an electronic bill. Credit investigation data of a specific enterprise may be obtained through analysis based on the credit investigation service contract. In another example, the derivative service contract herein may further be an on-chain lottery service contract deployed to encourage bill issuance, a talent excitation contract, a tax refund service contract, and the like.

The management chain shown in FIG. 2 is mainly configured to process a management service flow with a small data volume and a constant status, and may be configured to perform internal management on some taxation data since openness of the entire management chain is low. However, the bill chain shown in FIG. 2 may be configured to process some real-time bill service flows whose data is frequently requested for a long time. The entire bill chain has high openness and may allow a relevant authority in a life cycle of an electronic bill itself to participate in a corresponding bill service, for example, may allow a consensus node corresponding to an agent service provider to issue an electronic bill for a specific user currently requesting bill issuance. In addition, for the application contract chain shown in FIG. 2, a data amount does not need to be limited, and frequency fluctuations of service changes are relatively large. Various cooperative services, bill derivative services, and exploratory services may mainly be processed through the application contract chain. The application contract chain has the highest openness, and may run a smart contract deployed on the application contract chain by a participant authorized by the management chain, run an exploratory bill derivative service, and so on. In the embodiments of the present disclosure, in consideration of that the application contract chain has high openness and flexibility of service changes, a smart contract built in the application contract chain may have more contract security restrictions during execution. For example, a quantity of contract execution operations may be limited (for example, for the derivative service contract shown in FIG. 2, which contract methods in the derivative service contract can be accessed by the current entity object (that is, the second entity object) may be limited), and a quantity of storage resources that need to be consumed for accessing the derivative service contract and the like may be limited (that is, invocation of the smart contract on the application contract needs to consume a specific quantity of storage resource).

The consensus node in the three-chain system involved in the embodiments of the present disclosure and various nodes (for example, the management node mentioned below) and various servers (for example, the subnet creation server mentioned below) mentioned in the embodiments of the present disclosure may be independent physical servers, or may be a server cluster or a distributed system formed by a plurality of physical servers, or may be cloud servers providing a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform.

When obtaining data, such as registration data information, a service participation permission credential, and bill information in an electronic bill, of an entity object (for example, the personal user or the enterprise user), prescription information in an electronic prescription, or certificate information in an electronic certificate, across chains, the consensus node in the embodiments of the present disclosure may display a prompt interface or a popup window. The prompt interface or popup window is configured to prompt the entity object that the data, such as the registration data information, the service participation permission credential, and the bill information in the electronic bill, is currently collected. Execution of an operation related to data obtaining is started only after a confirm operation performed by the entity object on the prompt interface or the popup window is received; otherwise, the execution is ended.

In addition, in specific implementations of the present disclosure, service data (for example, bill issuance information, credit investigation information, tax refund information, and the like of a user, information, such as entry and exit losses and an enterprise qualification, of an enterprise, and contract information, certificate information, prescription information, and the like of a user or an enterprise) of an entity object, such as a user, an enterprise, and an institution, may be involved. When the foregoing embodiments of the present disclosure are applied to a product or technology, a permission or an approval from an entity object, such as a user, an enterprise, and an institution, needs to be obtained. In addition, collection, use, and processing of relevant data need to comply with relevant laws, regulations, and standards of relevant countries and regions.

The method provided in the present disclosure may also be applied to a blockchain electronic document platform based on a multi-blockchain. The blockchain electronic document platform may be a service platform in the foregoing blockchain electronic document system. In the blockchain electronic document platform, to lower the hybridity of data storage on the chain, a multi-chain system based on a blockchain electronic document may also be provided, and the multi-chain system mainly involves a blockchain electronic document three-chain network. For a structure of the blockchain electronic document three-chain network, reference may be made to the blockchain electronic bill three-chain network shown in FIG. 2. A management chain (that is, the foregoing target chain), a document chain (that is, the foregoing first chain), and an application contract chain (that is, the foregoing second chain) may also be deployed in the blockchain electronic document three-chain network. In a service scenario in which a blockchain is circulated as blockchain electronic document core data, functional characteristics independently executing different services may be provided for the entire blockchain electronic document platform through mutual cooperation between the management chain, the document chain, and the application contract chain. For the functional characteristics thereof, reference may be made to the foregoing descriptions of the blockchain electronic bill three-chain network, and details are not described herein again.

For example, a consensus node (that is, the foregoing second consensus node) participating in maintaining the application contract chain may confirm service authority by reading service association information (for example, service association information A) on the management chain across chains and may also execute a corresponding document derivative service by reading core data (for example, prescription information in an electronic prescription on the document chain) on the document chain across chains (for example, may execute the foregoing prescription statistics service based on prescription information read from the document chain, to obtain medication information of a specific hospital).

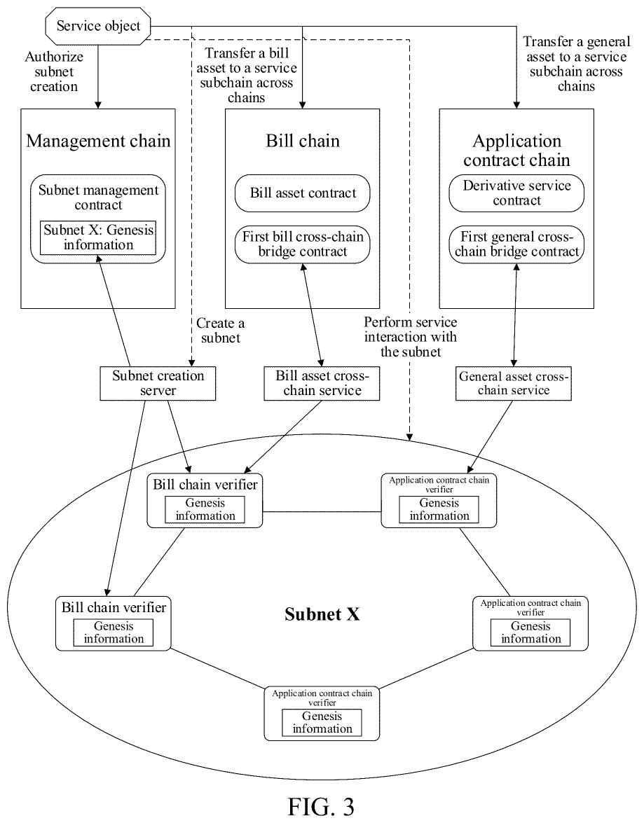

For case of understanding, referring to FIG. 3, FIG. 3 is a schematic diagram of interaction in a blockchain electronic bill scenario according to an embodiment of the present disclosure. A process of the interaction may occur in the blockchain electronic bill platform shown in FIG. 2. In the blockchain electronic bill platform, to meet requirements of service forms, a subnetwork protocol for creating a service subnetwork in a blockchain multi-chain architecture and interacting with the service subnetwork is provided, and the subnetwork protocol indicates a method for creating and running a service subchain. As shown in FIG. 3, in the blockchain electronic bill scenario, authorization may be performed through the management chain (that is, the foregoing target chain), nodes may be built quickly by reusing verifiers (that is, consensus nodes) of the bill chain (that is, the foregoing first chain) and application contract chain (that is, the foregoing second chain), and an asset state cross-chain capability between the service subchain and the bill chain and between the service subchain and the application contract chain may be further provided. Main participants that create and run the service subchain (for example, a service subchain corresponding to a subnet X) and their respective corresponding functions are described below. A process of interaction between participants in a blockchain electronic document scenario is similar to this, and therefore, details are not described again.

For example: (1) Management chain: A subnet management contract is deployed on the chain, and before starting a new service subnetwork, only after obtaining authorization from a taxation management department, a service object can apply to the management chain for creation of the service subnetwork (for example, a service subnetwork whose network identifier is subnet X, which may be referred to as a subnet X for short), and related genesis block information may be written into a service subchain corresponding to the subnet X.

In the embodiments of the present disclosure, a user terminal corresponding to the service object is referred to as a service terminal. The service terminal may include, but is not limited to, smart terminals that can be configured to apply for creation of a service subnetwork, such as a smart phone, a tablet computer, a notebook computer, a desktop computer, a palmtop computer, a mobile Internet device (MID), a wearable device (for example, a smart watch or a smart bracelet), and a smart in-vehicle device.

(2) Subnet creation server (also referred to as a subnet creation service): After obtaining the authorization from the management chain, the service object may request the subnet creation server to create the subnet X. The subnet creation server is operated by the taxation management department and may request the management chain to perform authorization verification on the subnet X. After the verification succeeds, the subnet creation server may conditionally randomly select a bill chain verifier (that is, a bill consensus node), an application contract chain verifier (that is, an application consensus node), and a general verifier (that is, a general consensus node, which is usually formed through participation of a service object or an external institution) from a verifier node network (including a bill chain network and an application contract chain network) according to needs of a subnet service, to form a network of a verifier subnet (that is, a service subnetwork, for example, the subnet X). After a verification node in the service subnetwork is started, the verification node in the service subnetwork starts subnet consensus, for example, executing a temporary service associated with a bill service (for example, counting a quantity of electronic bills).

(3) Bill chain: The bill chain manages a full life cycle and a state of a bill asset. A bill asset contract and a first bill cross-chain bridge contract are deployed on the bill chain. The bill chain may perform cross-chain interaction of bill assets with a bill asset cross-chain service (also be referred to as a bill data cross-chain service).

(4) Application contract chain: The application contract chain manages data (that is, a general asset, for example, credit investigation information and tax refund information) related to an electronic bill and a taxation derivative service contract. A first general cross-chain bridge contract (also referred to as an application chain asset general cross-chain bridge contract) is deployed on the application contract chain. The application contract chain may perform cross-chain interaction of general assets related to a derivative service with a general asset cross-chain service (also referred to as an application chain data cross-chain service).

(5) Bill asset cross-chain service (that is, a first cross-chain relay): The bill asset cross-chain service is configured to perform cross-chain transfer of bill assets between the bill chain and the service subchain. Only a bill chain verifier has authority to access the bill asset cross-chain service. Therefore, if the corresponding service subchain needs to perform a related service after the cross-chain transaction of bill assets (e.g., cross-chain transfer and/or cross-chain relay of a bill asset) is performed, during creation of the service subnetwork, required participation of the bill chain verifier needs be specified.

(6) General asset cross-chain service (that is, a second cross-chain relay): The general asset cross-chain service is configured to perform cross-chain transfer of some general data and states between the application contract chain and the service subchain. Only the application contract chain verifier can access the general asset cross-chain service. Therefore, if the corresponding service subchain needs to perform a related service after the cross-chain transfer of related general assets and states on the application contract chain is performed, during creation of the service subnetwork, required participation of the application contract chain verifier needs be specified.

In the embodiments of the present disclosure, when needing to create a service subchain, the service object only needs to register basic information and related authority information (for example, whether cross-chain transfer of a bill is needed) of a subnet with the management chain without providing a verifier node (which may be referred to as a verifier for short, that is, a consensus node) of a service subnetwork. The subnet creation server of the system may select, according to needs of a user (that is, subnet registration configuration information submitted by a service object), verifier nodes currently existing in the bill chain network and the application contract chain network, to form a service subnetwork for the service object.

In view of the above, because the verifier nodes related to the bill chain and the application contract chain are reused, and the verifier nodes themselves also synchronize on-chain ledger data on the bill chain and the application contract chain in real time, through the data cross-chain service, cross-chain transfer of data from the bill chain and the application contract chain to the service subchain can be conveniently completed. In addition, the embodiments of the present disclosure may provide the service object with a convenient subchain use manner, which also reduces resource overheads of an additional verifier node.

The data cross-chain service (including a bill asset cross-chain service and a general asset cross-chain service) in FIG. 3 completes cross-chain transfer of related assets and state data from the bill chain and the application contract chain to the service subchain. Before using the data cross-chain function, a related cross-chain authority application needs to be submitted to the management chain first during creation of the service subchain. In addition, the cross-chain authority may also be written into genesis block information of the service subchain. The cross-chain authority is unchangeable throughout a life cycle of the service subchain. The data cross-chain service provides a cross-chain service for the service subchain only after the authority is verified.

During execution of data cross-chain transfer, the data cross-chain service needs to interact with an asset cross-chain bridge contract (including a second bill cross-chain bridge contract and a second general cross-chain bridge contract) that has been deployed in a genesis block of the service subchain, a first bill cross-chain bridge contract on the bill chain, and a first general cross-chain bridge contract on the application contract chain. The second bill cross-chain bridge contract and the second general cross-chain bridge contract cannot be updated autonomously on the service subchain.

Advantages of the service subchain in the embodiments of the present disclosure are: First, a startup procedure of the service subchain can be simplified. After registration of the service object, consensus nodes corresponding to the bill chain and the application contract chain may be directly reused, which eliminates the difficulty in providing verification nodes by the service object and avoids insecurity. Second, effective cross-chain services and cross-chain protocols are provided. The service subchain may perform cross-chain exchanging of service data on the bill chain and the application contract chain under security authorization, which allows the service object to conveniently run a subchain service (for example, an invoice taxation derivative service) on the service subchain.

In view of the above, the service subnetwork may allow the service object to have an independent service subchain more independently outside the application contract chain. The independent service subchain can provide the service object with a service with higher independent performance, independent data isolation, and high privacy. In addition, for a temporary service that generates a large amount of temporary data and unimportant data, the service subchain may be used as a temporary service chain. A large amount of ledger data run on the service subchain may not occupy main chain space of the application contract chain, which can also save a lot of costs for the service object and the management system.

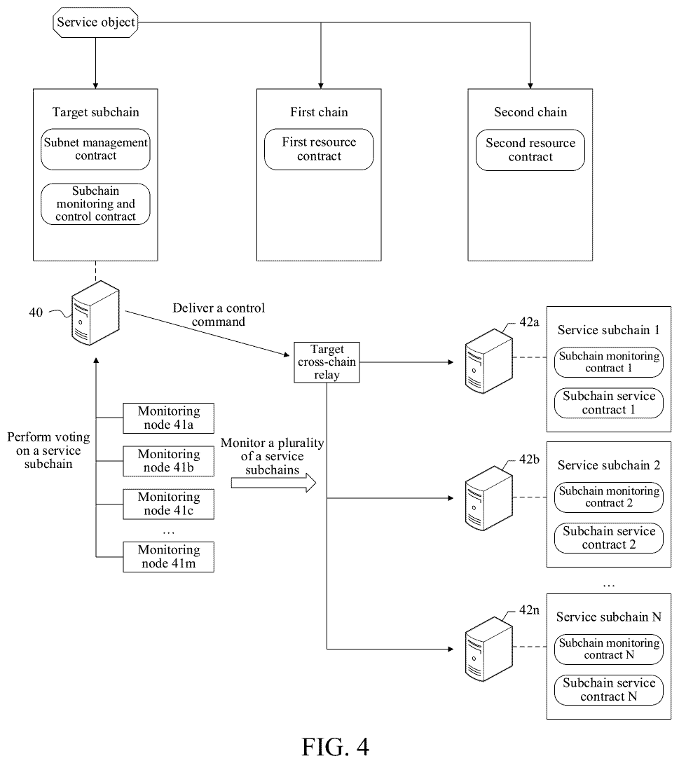

For case of understanding, referring to FIG. 4, FIG. 4 is a schematic diagram of a scenario of managing a subchain service in a multi-blockchain architecture according to an embodiment of the present disclosure. The multi-blockchain architecture may be a three-chain architecture including a target chain, a first chain, and a second chain. For example, the multi-blockchain architecture may be the foregoing blockchain electronic bill three-chain architecture (including the management chain, the bill chain, and the application contract chain), or may be the foregoing blockchain electronic document three-chain architecture (including the management chain, the document chain, and the application contract chain). This is not limited in the embodiments of the present disclosure. A service object in FIG. 4 may be any entity object having a subnet creation need. A service terminal of the service object may be a service node corresponding to the service object (for example, a service node in the service network 400a shown in FIG. 1), or may be a terminal device associated with the service node, which is not limited herein. In addition, a consensus node 40 in FIG. 4 may be a target consensus node. The target consensus node may be any consensus node (for example, the consensus node 10a in the consensus network 100a shown in FIG. 1) in a target chain network corresponding to the target chain.

The service object may apply, according to a service need, to a subnet management contract on the target chain for creation of one or more service subnetworks. A quantity of service subnetworks is not limited herein. Verification nodes in each service subnetwork may all originate from a consensus node (that is, a first consensus node, for example, a consensus node in the consensus network 200a shown in FIG. 1) in a first chain network corresponding to the first chain and a consensus node (that is, a second consensus node, which is, for example, a consensus node in the consensus network 300a shown in FIG. 1) in a second chain network corresponding to the second chain. A quantity of verification nodes in each service subnetwork is not limited in the embodiments of the present disclosure. A plurality of verification nodes in a same service subnetwork may be configured to jointly maintain a service subchain, and different service subchains may be configured to run different subchain services requested by the service object. As shown in FIG. 4, the plurality of service subchains may include a service subchain 1, a service subchain 2, . . . , and a service subchain N. Each service subchain herein is a blockchain independent of the target chain, the first chain, and the second chain, and different service subchains operate independently of each other. A service subnetwork corresponding to the service subchain 1 may include a plurality of verification nodes, for example, a verification node 42a. The verification node 42a may be configured to execute, based on a subchain service contract 1 deployed on the service subchain 1, a subchain service A requested by the service object. A service subnetwork corresponding to the service subchain 2 may include a plurality of verification nodes, for example, a verification node 42b. The verification node 42b may be configured to execute, based on a subchain service contract 2 deployed on the service subchain 2, a subchain service B requested by the service object. A service subnetwork corresponding to the service subchain N may include a plurality of verification nodes, for example, a verification node 42n. The verification node 42n may be configured to execute, based on a subchain service contract N deployed on the service subchain N, a subchain service N requested by the service object. The verification node 42a, the verification node 42b, and the verification node 42n in FIG. 4 may be the foregoing first consensus node or the foregoing second consensus node, which is not limited herein. In addition, a first resource contract (for example, a bill asset contract) is deployed on the first chain, and a corresponding transaction service (for example, the foregoing bill service) may be executed based on the first resource contract. A second resource contract (for example, a derivative service contract) is deployed on the second chain, and a corresponding transaction service (for example, the foregoing bill derivative service) may be executed based on the second resource contract. Verification nodes in each service subnetwork all can execute a corresponding subchain service based on relevant resources (which, for example, may be an electronic bill associated with the subchain service or partially-authorized-to-be-visible bill information in the electronic bill, or may be an electronic document associated with the subchain service or partially-authorized-to-be-visible document information (for example, certificate information in an electronic certificate) in the electronic document; or may be a general bill associated asset (for example, credit investigation information or taxation information) associated with the subchain service or partially-authorized-to-be-visible asset association information asset association information in the general bill associated asset or may be a general document associated asset (for example, qualification information or a prescription statistics collection result) associated with the subchain service or partially-authorized-to-be-visible asset association information in the general document associated asset) transferred from the first chain and the second chain across chains.

In the multi-blockchain architecture, a plurality of service subchains may be created for the blockchain system based on related subnetwork protocols. To ensure ordered execution for each service subchain, the embodiments of the present disclosure provide a protocol framework for managing each service subchain. After the service subnetwork is created, a target consensus node (for example, the foregoing consensus node 40) in the target chain network may manage subnet service authority based on a subchain control contract deployed on the target chain (based on a cross-chain service function), and one or more management nodes (that is, Warden, which may also be referred to as an administrator) may manage the subchain service after the subchain service is started. The management node herein may be configured to confirm a chain height of a corresponding service subchain and feed back a service risk through transitive voting.

As shown in FIG. 4, in the embodiments of the present disclosure, the service subchain 1 to the service subchain N may be managed by management nodes in a management node cluster (which may also be referred to as a management service cluster) associated with the target chain. A plurality of management nodes may be deployed in the management node cluster. The plurality of management nodes herein may include a management node 41a, a management node 41b, a management node 41c, . . . , and a management node 41m shown in FIG. 4. A quantity of management nodes in the management node cluster is not limited herein. Each management node may be an independent management institution, may flexibly customize its own management logic to manage a corresponding service subchain that the management node expects to manage, and can obtain all data on the service subchain (for example, a related service execution result and parameter information, such as a bill issuance parameter related to an electronic bill, in a corresponding subchain service contract). Therefore, the management node may also be understood as a full simplified payment verification (SPV) node. In some embodiments, one management node may manage one or more service subchains at the same time. Correspondingly, one service subchain may also be managed by a plurality of management nodes at the same time. In an actual application, a correspondence between a management node and a service subchain may be configured according to a service requirement, which is not limited herein. For example, the management node 41a shown in FIG. 4 may manage the service subchain 1 and the service subchain 2. The management node 41b may manage the service subchain 1 and the service subchain N.

Before executing management logic on the service subchain, the management node needs to register a management identity thereof in the subchain control contract on the target chain first, so that the target chain can subsequently perform identification on voting authority of the identity of the management node. In some embodiments, any one of the plurality of service subchains may be referred to as a target service subchain (for example, the service subchain 1 shown in FIG. 4). Correspondingly, a service subnetwork corresponding to the target service subchain may be referred to as a target service subnetwork (for example, a service subnetwork corresponding to the foregoing service subchain 1), and a subchain service executed by the target service subnetwork may be referred to as a target service (for example, the foregoing subchain service A, where the subchain service A may be the foregoing bill temporary service or document temporary service). That is, the target service subnetwork is constructed by the target consensus node based on the target service requested by the service object. Similarly, a plurality of management nodes successfully perform identity registration for the target service subchain in the subchain control contract may be collectively referred to as registered nodes. In this way, each registered node is associated with the target service subchain.

For case of understanding, using an example in which the target service subchain is the foregoing service subchain 1, a process of confirming a chain height of the target service subchain is described below. Assuming that a plurality of management nodes (such as the management node 41a, the management node 41b, and the management node 41c) manage the service subchain 1, the plurality of management nodes may all perform voting for the service subchain 1 (for example, vote to confirm a chain height of the service subchain 1) based on their respective management logic, so that chain height voting information of the management nodes for the service subchain 1 can be obtained. For example, chain height voting information of the management node 41a for the service subchain 1 is chain height voting information 1, chain height voting information of the management node 41b for the service subchain 1 is chain height voting information 2, and chain height voting information of the management node 41c for the service subchain 1 is chain height voting information 3. When obtaining the chain height voting information 1, the chain height voting information 2, and the chain height voting information 3, the consensus node 40 may first identify, based on the subchain control contract on the target chain, whether the corresponding management nodes (that is, the management node 41a, the management node 41b, and the management node 41c) are registered nodes that have been registered, and then perform subsequent calculation based on an identification result.

Descriptions are provided by using the chain height voting information 1 as an example. The consensus node 40 may identify, based on the subchain control contract, whether the corresponding management node 41a is a specific registered node that has performed identity registration for the service subchain 1 in the subchain control contract. For case of distinction, in the embodiments of the present disclosure, the registered node may be referred to as a target registered node. The target registered node may be any one of the foregoing plurality of registered nodes performing identity registration for the target service subchain in the subchain control contract. After it is determined that the management node 41a is the target registered node, a voting type of the chain height voting information 1 may be determined based on a node registration identity of the target registered node. Similarly, the consensus nodes 40 may also determine voting types of the chain height voting information 2 and the chain height voting information 3. In the embodiments of the present disclosure, node registration identities registered by all registered nodes in the subchain control contract may be divided into two types, namely, a first-type node registration identity and a second-type node registration identity. An identity level of the first-type node registration identity is higher than an identity level of the second-type node registration identity. Correspondingly, a management node having a first-type node registration identity registered in the foregoing subchain control contract may be referred to as a first-type management node. The first-type management node herein may be understood as a one-vote veto-type management node. A voting type of chain height voting information determined by the first-type management node based on the first-type node registration identity may be referred to as a first voting type. Similarly, a management node having a second-type node registration identity registered in the foregoing subchain control contract may be referred to as a second-type management node. The second-type management node herein may be understood as an ordinary-type management node. A voting type of chain height voting information determined by the second-type management node based on the second-type node registration identity may be referred to as a second voting type. A voting type of each piece of chain height voting information obtained by the target consensus node affects a finally calculated target chain height of the target service subchain.

When a management node performs identity registration in the subchain control contract, a corresponding node registration identity may be independently registered for each service subchain that the management node expects to manage. Different service subchains may register the same type of node registration identity or different types of node registration identities. This is not limited in the embodiments of the present disclosure. For example, the management node 41a may register a first-type node registration identity for the service subchain 1, and the management node 41a may register a second-type node registration identity for the service subchain 2. In a plurality of management nodes managing a same service subchain, there may be only one type of management nodes (which, for example, are all first-type management nodes or second-type management nodes), or there may be different types of management nodes (that is, there are both first-type management nodes and second-type management nodes). Types of the management nodes are not limited in the embodiments of the present disclosure.

The consensus node 40 may determine a target chain height (for example, a chain height k, where k is a positive integer) of the service subchain 1 based on the foregoing chain height voting information 1 to chain height voting information 3, a voting type of each of the three pieces of chain height voting information, and the subchain control contract. The target chain height refers to a chain height of the target service subchain currently confirmed by the target consensus node. In the target service subnetwork, as a target service is executed, a corresponding verification node continuously generates new blocks and adds the new blocks to the target service subchain. Moreover, each block on the target service subchain has its own block height. The block height herein may be understood as an identifier of the block, and is configured for measuring a distance from a specific block to the first block (that is, a genesis block of the target service subchain) on the target service subchain. A location of the specific block on the target service subchain can be accurately learned of based on the block height, which is equivalent to locating coordinates for the block. For example, assuming that there are five blocks in the foregoing service subchain 1, a block height of the first block in the service subchain 1 is 0, a block height of the second block is 1 . . . , and by analogy, a block height of the fifth block is 4. In this case, for a new block to be added to the service subchain, a corresponding block height is 5. Based on this, in the embodiments of the present disclosure, a block height corresponding to blocks on a service subchain may be collectively referred to as a chain height of the service subchain. For example, still using the foregoing service subchain 1 as an example, assuming that a chain height of the service subchain 1 at a specific moment is 4 (that is, the current service subchain 1 includes 5 blocks), if the verification node 42a further adds a new block to the service subchain 1 at this moment, the chain height of the service subchain 1 accumulates to 5. In other words, the chain height of the service subchain continuously accumulates as new blocks are chained. Correspondingly, the management node and the target consensus node may perform height confirmation on any chain height of the service subchain. In the embodiments of the present disclosure, the chain height of the service subchain is determined through transitive voting. In other words, when the target consensus node determines a target chain height of the target service subchain, all chain heights before the target chain height are determined. For example, assuming that a chain height of the service subchain 1 currently determined by the consensus node 40 is k (for example, k=4), the service object can trust correctness and reliability of service execution results associated with k and chain heights before k on the service subchain 1.

The consensus node 40 may generate height confirmation information corresponding to a target chain height (for example, the foregoing chain height k) of the service subchain 1 based on the subchain control contract, and may transmit the height confirmation information to the verification node 42a through a target cross-chain relay. The verification node 42a is configured to write a target chain height corresponding to the height confirmation information into a subchain management contract 1 on the service subchain 1. The subchain management contract 1 is configured to instruct the verification node 42a to determine, based on the target chain height, a chain height obtained after execution of a subchain service A requested by a service object. In other words, at the target chain height of the service subchain 1 that has been confirmed, the verification node 42a may continue invoking the subchain service contract 1 to execute the subchain service A, and cumulatively produce blocks based on obtained service execution results, and may add the produced new block to the service subchain 1, to obtain a chain height obtained after execution of the subchain service A. The service subnetwork in the embodiments of the present disclosure is essentially a consensus network. Therefore, when a block is chained, consensus needs to be reached on the block among all verification nodes in the service subnetwork, and only a block on which consensus is reached can be added to a corresponding service subchain.

The target cross-chain relay may be configured to isolate the target service subnetwork and the target chain network, and provide a cross-chain service function. The target cross-chain relay may be an independent relay server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a CDN, big data, and an artificial intelligence platform. In addition, cross-chain data exchanging may also be performed between other different consensus networks in the core consensus network through related cross-chain relays. For example, cross-chain data exchanging may be performed between the first chain network and the service subnetwork through a first cross-chain relay. In another example, cross-chain data exchanging may be performed between the second chain network and the service subnetwork through a second cross-chain relay. In still another example, cross-chain data exchanging may be performed between the first chain network and the second chain network through a third cross-chain relay.

For a process of performing height confirmation on the chain heights of the other service subchains (such as the service subchain 2 and the service subchain N) in FIG. 4, reference may be made to the foregoing process of performing height confirmation on the chain height of the service subchain 1. Details are not described herein again.

In addition, when detecting that there is a service risk on the service subchain, the management node in the embodiments of the present disclosure may further feed back the service risk to the target chain by voting against a risk height.

In view of the above, the embodiments of the present disclosure provide a management protocol for a subchain service in a three-chain platform. Based on the management protocol, any service subchain (such as the foregoing service subchain 1) can be flexibly managed, so that a subchain service of the service subchain can be managed and controlled without affecting independent operation of the service subchain.

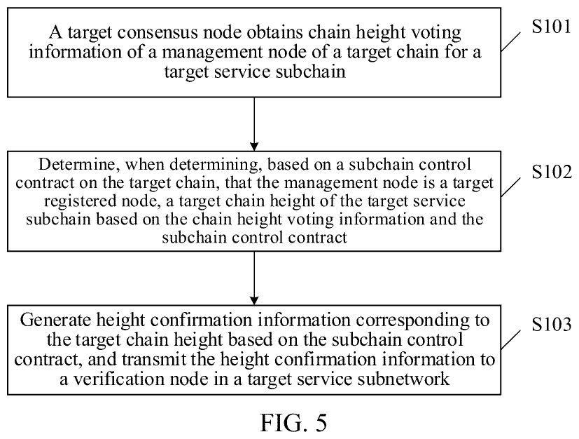

For a process of performing height confirmation on a chain height of the service subchain and a process of feeding back and processing a service risk that exists on the service subchain, reference may be made to the following embodiments corresponding to FIG. 5 to FIG. 8.

Referring to FIG. 5, FIG. 5 is a schematic flowchart of a data processing method for a multi-blockchain according to an embodiment of the present disclosure. As shown in FIG. 5, the method may be performed by a target consensus node in the target chain network. For example, the target consensus node may be any consensus node in the consensus network 100a shown in FIG. 1. The method may include the following operation S101 to operation S104.

Operation S101: The target consensus node obtains chain height voting information of a management node of a target chain for a target service subchain.

The multi-blockchain in this embodiment of the present disclosure may include a target chain and a target service subchain. A target chain network corresponding to the target chain is independent of a target service subnetwork corresponding to the target service subchain. In addition, the target service subnetwork is constructed by a target consensus node in the target chain network based on a target service requested by a service object. For a process of constructing the target service subnetwork, reference may be made to the related descriptions in the embodiment corresponding to FIG. 3, and details are not described herein again. The target service requested by the service object may be the foregoing bill temporary service (for example, a bill statistics service, a taxation audit service, a credit review service, an entry and exit loss analysis service, an enterprise qualification comparison service, a credit investigation analysis service, a social service, a credit purchase analysis service, a tax refund review service, or a lottery winning check service) or document temporary service (for example, a cooperation risk prediction service, an enterprise qualification review service, a drug procurement service based on a prescription statistics result, a qualification incentive service, or a document sensitive information detection service).

A subchain control contract configured for controlling the target service subchain is deployed on the target chain. The subchain control contract may be a smart contract deployed by the target consensus node for the target service subchain based on a management contract template on the target chain. In an actual application, the subchain control contract may record service management logic configured for managing the corresponding target service subchain, so that the target service subchain can be managed and controlled by the target chain based on the subchain control contract. When expecting to manage a target service subchain, a specific management node needs to perform identity registration in the subchain control contract, to become a registered node that performs identity registration for the target service subchain in the subchain control contract, and voting authority granted by the target chain can be configured for the management node when the identity registration succeeds. Moreover, a management node having voting authority may perform voting on a chain height of the target service subchain in a process of managing the target service subchain, so that chain height voting information of the management node for the target service subchain is obtained. In addition, the subchain control contract may include a target registered node that performs identity registration for the target service subchain. The target registered node may be any one of a plurality of registered nodes that perform identity registration for the target service subchain in the subchain control contract. In other words, the target service subchain may be managed simultaneously by one or more management nodes that have performed identity registration.

The target consensus node may actively obtain chain height voting information of all management nodes associated with the target chain for the target service subchain. For example, the target consensus node may configure a voting information collection time interval (which, for example, is set to 5 minutes), to collect chain height voting information of related management nodes for the target service subchain according to the voting information collection time interval. Each collection of chain height voting information may correspond to a collection timestamp. The voting information collection time interval is a time interval between collection timestamps at which the target consensus node collects corresponding chain height voting information twice before and after. For example, if the target consensus node collects chain height voting information A generated by the management node at a first collection timestamp (such as a timestamp T1), the target consensus node may then collect chain height voting information B generated by the management node at a second collection timestamp (such as a timestamp T2). The second collection timestamp herein is a collection timestamp next to the first collection timestamp, and a time interval between the second collection timestamp and the first collection timestamp is equal to the foregoing voting information collection time interval. In an actual application, the voting information collection time interval of the target consensus node may be configured according to a service requirement. In some embodiments, the target consensus node may further perform real-time detection on the management node associated with the target chain, and may collect, when detecting that the management node generates chain height voting information for the target service subchain, the chain height voting information detected by the target consensus node. In this way, each time the management node generates corresponding chain height voting information, the target consensus node can obtain the chain height voting information timely. In some embodiments, the management node may also actively transmit chain height voting information for the target service subchain to the target consensus node. That is, each time the management node generates corresponding chain height voting information, the management node immediately transmits the chain height voting information to the target consensus node for processing.

Operation S102: Determine, when determining, based on a subchain control contract on the target chain, that the management node is a target registered node, a target chain height of the target service subchain based on the chain height voting information and the subchain control contract.

In some embodiments, when determining, based on the subchain control contract on the target chain, that the management node is a target registered node, the target consensus node determines the target chain height of the target service subchain based on the chain height voting information and the subchain control contract in the following manner: determining a voting type of the chain height voting information based on a node registration identity of the target registered node; and determining the target chain height of the target service subchain based on the chain height voting information, the voting type of the chain height voting information, and the subchain control contract.

When obtaining the foregoing chain height voting information, the target consensus node may identify the obtained chain height voting information based on the subchain control contract on the target chain, to determine a voting type of the chain height voting information, that is, classify the obtained chain height voting information, to determine whether chain height voting information with a first voting type and chain height voting information with a second voting type exist. That is, in some embodiments, a voting type of the chain height voting information includes the first voting type and the second voting type.

For example, the chain height voting information includes first-type height voting information. The first-type height voting information herein is voted-for information. To be specific, the first-type height voting information is chain height voting information generated when the management node performs voting confirmation on the chain height of the target service subchain. For example, assuming that a management node W performs voting on a service subchain X, and performs voting confirmation on a chain height k of the service subchain X during one vote (that is, performs voting on the chain height k), correspondingly obtained chain height voting information is first-type height voting information (or voted-for information). The first-type height voting information herein includes a node identifier (such as a network address, a node identification number, or a node name of the management node) of the management node, a public key certificate of the management node, a voted-for height generated when the management node performs voting on the chain height of the target service subchain, and signature information (which may also be referred to as first signature information) of the management node. The signature information of the management node is obtained by the management node after performing signature addition on the voted-for height based on private key information of the management node. In other words, when the management node performs voting on the chain height of the target service subchain, the chain height (for example, the foregoing chain height k) that the management node votes to confirm may be obtained. For ease of understanding and distinction, in this embodiment of the present disclosure, chain heights that the management node votes to confirm for the target service subchain may be collectively referred to as voted-for heights. Then, the management node may perform signature addition on the voted-for height based on the private key information configured by the management node, to obtain signature information of the management node, and may generate first-type height voting information of the management node based on the obtained voted-for height, the signature information of the management node, the node identifier of the management node, and the public key certificate of the management node.

In some embodiments, the subchain control contract includes node registration configuration information of a registered node associated with the target service subchain. The node registration configuration information may be configuration information obtained after the registered node performs identity registration in the subchain control contract. The node registration configuration information may include a node identifier (such as a network address, a node identification number, or a node name of the registered node) of the registered node and a public key certificate of the registered node, and may further include information such as an identity (that is, a node registration identity, for example, a first-type node registration identity or a second-type node registration identity) registered by the registered node for the target service subchain and a chain identifier (for example, a chain identification number or a subchain name of the target service subchain) of the target service subchain managed by the registered node. The public key certificate of the registered node is obtained after the target consensus node performs, by invoking the subchain control contract, identity registration for registered node information submitted by the registered node. The registered node information herein includes at least one of the following: a node identifier of the registered node, a node registration identity whose registration is applied for the target service subchain, or information, such as a chain identifier, of a target service subchain that the registered node expects to manage. In a case that the target consensus node successfully configures a corresponding public key certificate for the management node that requests to register a corresponding identity, the management node that requests to register a corresponding identity may be used as a registered node, and the public key certificate configured for the management node that serves as the registered node may be written into the target chain (for example, the management chain).

In addition, after writing the public key certificate configured for the management node that serves as the registered node into the target chain, the target consensus node may further return private key information synchronously configured for the management node to the management node, so that the management node can sign, by using the obtained private key information, the voted-for height that the management node votes for the target service subchain confirms, to obtain the signature information of the management node.

In some embodiments, there may be one or more registered nodes. Based on this, a process in which the target consensus node determines the voting type of the chain height voting information may include: The target consensus node may obtain the node identifier of the management node from the first-type height voting information, and search the node identifier of the registered node for a target node identifier the same as the node identifier of the management node, the target node identifier being a node identifier of a target registered node in a plurality of registered node. If finding the target node identifier in the node identifier of the registered node, the target consensus node may obtain a public key certificate of the target registered node corresponding to the target node identifier from the public key certificate of the registered node, and in this case, may use the obtained public key certificate of the target registered node as a target public key certificate. Similarly, the public key certificate of the management node included in the first-type height voting information may be used as a to-be-processed public key certificate, and signature verification is performed on the signature information of the management node based on the to-be-processed public key certificate and the target public key certificate, to obtain a signature verification result of the management node. When the signature verification result indicates that the signature verification succeeds, the management node is determined as the target registered node, and then, the target consensus node may determine a voting type of the first-type height voting information based on the node registration identity of the target registered node.

In some embodiments, if the target consensus node does not find the target node identifier in the node identifier of the registered node, the management node is an invalid node, that is, the management node does not register a corresponding identity in the subchain control contract.

For ease of understanding, using the management node 41a in FIG. 4 as an example herein, it is assumed that the chain height voting information 1 of the management node 41a for the service subchain 1 is first-type height voting information, and the chain height voting information 1 includes a node identifier 411a of the management node 41a, a public key certificate 412a of the management node 41a, a voted-for height 413a when the management node 41a performs voting on the chain height of the target service subchain 1, and signature information 414a of the management node 41a. The subchain control contract includes node registration configuration information of four registered nodes (such as a registered node 1, a registered node 2, a registered node 3, and a registered node 4) associated with the service subchain 1. The node registration configuration information may include a node identifier 1a and a public key certificate 1b corresponding to the registered node 1, a node identifier 2a and a public key certificate 2b corresponding to the registered node 2, a node identifier 3a and a public key certificate 3b corresponding to the registered node 3, and a node identifier 4a and a public key certificate 4b corresponding to the registered node 4. In this case, the consensus node 40 may find a node identifier that is the same as the node identifier 411a in the node identifier 1a, the node identifier 2a, the node identifier 3a, and the node identifier 4a. Assuming that it is found that the node identifier 1a is the same as the node identifier 411a, the node identifier 1a may be used as the target node identifier. Correspondingly, the public key certificate 1b of the registered node 1 indicated by the node identifier 1a may be used as the target public key certificate, and the public key certificate 412a of the management node 41a may be used as the to-be-processed public key certificate. Therefore, the consensus node 40 may perform signature verification on the signature information 414a of the management node 41a based on the public key certificate 1b and the public key certificate 412a, and when the verification of the signature information 414a succeeds, it may be determined that the management node 41a is the registered node 1 (that is, the target registered node).

In this embodiment of the present disclosure, signature verification may be performed on the signature information of the management node with reference to certificate data information (for example, version information of the certificate, a hash value of the certificate, and a root certificate hash value associated with the hash value of the certificate) of the to-be-processed public key certificate, to ensure reliability of public key information in the public key certificate (that is, the foregoing to-be-processed public key certificate) configured for signature verification.

For example, the target consensus node may use certificate data information in the to-be-processed public key certificate (for example, the foregoing public key certificate 412a) as to-be-processed certificate information, and use certificate data information in the target public key certificate (for example, the foregoing public key certificate 1b) as target certificate information. The target consensus node compares the to-be-processed certificate information with the target certificate information, to obtain a comparison result; and performs, in response to the comparison result indicating the to-be-processed certificate information being consistent with the target certificate information, signature verification on the signature information of the management node based on public key information in the to-be-processed public key certificate, and uses a verification result obtained when the signature verification succeeds as the signature verification result of the management node.

In some embodiments, when the comparison result indicates that the to-be-processed certificate information is inconsistent with the target certificate information, the to-be-processed public key certificate needs to be updated with the public key certificate (that is, the target public key certificate) of the target registered node read from the target chain, so that signature verification may be performed on the signature information of the management node based on public key information in the updated to-be-processed public key certificate, to ensure successful execution of the voting block production solution in the target chain. In addition, in this embodiment of the present disclosure, verification may be performed on validity of the to-be-processed public key certificate. For example, when it is detected that usage duration of the to-be-processed public key certificate exceeds a configured certificate validity period (that is, the to-be-processed public key certificate has expired), a certificate update may be performed on the public key certificate used by the management node by using the target public key certificate read from the target chain.

In this embodiment of the present disclosure, the management node can be supported to apply registration of either of two types of node registration identities for the target service subchain. For example, the node registration configuration information includes a first-type node registration identity or a second-type node registration identity registered by the registered node for the target service subchain. Then, the target consensus node may search the node registration configuration information for the node registration identity of the target registered node corresponding to the target node identifier, and may use the found node registration identity of the target registered node as a target node registration identity. When the target node registration identity is the first-type node registration identity, the target consensus node may determine, based on the first-type node registration identity, that the voting type of the first-type height voting information is a first voting type. Alternatively, when the target node registration identity is the second-type node registration identity, the target consensus node may determine, based on the second-type node registration identity, that the voting type of the first-type height voting information is a second voting type. For example, when the consensus node 40 recognizes that a node registration identity registered by the management node 42a for the service subchain 1 is a first-type node registration identity, a voting type of the chain height voting information 1 for the service subchain 1 is a first voting type.

In an actual application, when managing different service subchains at the same time, one management node may register corresponding identities independently for the different service subchains, and when the identities are successfully registered, the target consensus node may configure different public key certificates and corresponding private key information for the management node for the different service subchains. For example, a management node W may register a first-type node registration identity for a service subchain X1. In this case, the target consensus node may configure a public key certificate Y1 and private key information Z1 for the management node W for the service subchain X1. The management node W may further register a second-type node registration identity for a service subchain X2. In this case, the target consensus node may configure a public key certificate Y2 and private key information Z2 for the management node W for the service subchain X2. In this way, when the management node W requests data synchronization from the service subchain (for example, the service subchain X1) managed by the management node W, the service subchain may also perform signature verification on signature information in a received data synchronization request, to determine whether the management node W can obtain all data on the service subchain.

Because each management node performs voting on the target service subchain independently based on its own management logic, chain heights that different management nodes vote to confirm at the same moment for the target service subchain may not be exactly the same. In this case, the target consensus node may calculate a target chain height of the target service subchain based on chain height voting information determined by the different management nodes, voting types of the chain height voting information, and the subchain control contract, and write the target chain height to the target chain.

In some embodiments, the foregoing management nodes may include a first-type management node (or a one-vote veto-type management node) and a second-type management node (or an ordinary-type management node). The first-type management node is a management node registering a first-type node registration identity in the subchain control contract. The second-type management node is a management node registering the second-type node registration identity in the subchain control contract. An identity level of the first-type node registration identity is higher than an identity level of the second-type node registration identity. Therefore, voting effects corresponding to the management nodes registering different node registration identities are different. Correspondingly, in this case, the chain height voting information obtained by the target consensus node includes the first-type height voting information (that is, voted-for information) of the first-type management node and the second-type management node for the target service subchain. The first-type height voting information may include first chain height voting information of the first voting type determined by the first-type management node based on the first-type node registration identity, and second chain height voting information of the second voting type determined by the second-type management node based on the second-type node registration identity.

Based on this, in this embodiment of the present disclosure, a voted-for height generated when the first-type management node performs voting on the chain height may be used as a first voted-for height, and a voted-for height generated when the second-type management node performs voting on the chain height may be used as a second voted-for height. Further, the target consensus node may invoke, based on the first voted-for height, the subchain control contract to determine a reference voting height threshold for the target service subchain, and determine the target chain height of the target service subchain based on the reference voting height threshold, the first voted-for height, and the second voted-for height.

A meaning that the management node registers the first-type node registration identity lies in that: In a process of performing height confirmation, the target consensus node may first determine a reference voting height threshold based on the first voted-for height determined by the first-type management node registering the first-type node registration identity for the target service subchain. In this way, a target chain height of the target service subchain finally confirmed by the target consensus node in this round is not higher than the reference voting height threshold, so that a voting effect of “one-vote veto” by the first-type management node is achieved. However, the second-type management node registering the second-type node registration identity does not have a similar “one-vote veto” capability. Therefore, differentiated voting effects of different types of management nodes can be implemented, thereby improving flexibility of management logic.

In some embodiments, there may be a plurality of management nodes (for example, M management nodes, where M is a positive integer greater than 2). For example, it is assumed that the M management nodes include M1 first-type management nodes and M2 second-type management nodes, and each management node corresponds to a voted-for height for the target service subchain. Therefore, correspondingly, a quantity of first voted-for heights is M1, and a quantity of second voted-for heights is M2, where M1 and M2 are both positive integers, and M=M1+M2. In this case, a process in which the target consensus node performs height confirmation on the target service subchain may be as follows: The target consensus node may invoke a height conformation method (that is, a confirmation manner for confirming a height) in the subchain control contract to use a first voted-for height having a minimum height in the M1 first voted-for heights as a reference voting height threshold (which, for example, is m, where m is a positive integer) of the target service subchain. The target consensus node may obtain voted-for heights less than or equal to the reference voting height threshold from the M1 first voted-for heights and the M2 second voted-for heights, use the obtained voted-for heights as candidate voting heights, and use a voted-for height having a maximum height in the candidate voting heights as a target voted-for height (which, for example, is k, where k is a positive integer). Subsequently, the target consensus node may use voted-for heights greater than or equal to the target voted-for height in the M1 first voted-for heights and the M2 second voted-for heights as to-be-processed heights. When it is detected based on the height confirmation method that a quantity of the to-be-processed heights is greater than a set vote count threshold, the target consensus node may use the target voted-for height as a currently confirmed target chain height of the target service subchain. The vote count threshold herein is greater than or equal to (M1+M2)/2.

In other words, if there is a one-vote veto-type management node in the plurality of management nodes, and a voted-for height that the one-vote veto-type management node votes to confirm for the chain height of the target service subchain is m (that is, the reference voting height threshold), the target chain height currently conformed by the target consensus node for the target service subchain is not higher than m. On the premise that a maximum value k is found in the voted-for heights determined by the plurality of management nodes, and k is not greater than m, it is further required that voted-for heights of management nodes (for example, more than half of the management nodes, including one-vote veto-type management nodes and ordinary-type management nodes) whose quantity is higher than the vote count threshold for the target service subchain is greater than or equal to k.

For example, assuming that there are four management nodes that manage the service subchain X, namely, a management node C1, a management node C2, a management node C3, and a management node C4, where the management node C1 and the management node C2 are first-type management nodes (that is, M1=2), the management node C3 and the management node C4 are second-type management nodes (that is, M2=2), and a voted-for height of the management node C1 for the service subchain X is 105, a voted-for height of the management node C2 for the service subchain X is 106, a voted-for height of the management node C3 for the service subchain X is 104, and a voted-for height of the management node C4 for the service subchain X is 107, it may be determined, based on the height confirmation method in the subchain control contract, that a current reference voting height threshold of the service subchain X is 105 (that is, m=105). Further, voted-for heights less than or equal to 105 may be obtained from the four voted-for heights as candidate voting heights. In this case, the candidate voting heights include 104 and 105, and a maximum height in the two candidate voting heights may be used as the target voted-for height (that is, k=105). Subsequently, based on the height confirmation method in the subchain control contract, voted-for heights greater than or equal to 105 may be obtained from the foregoing four voted-for heights as to-be-processed heights. In this case, the to-be-processed heights include 105, 106, and 107, and it can be learned that a quantity of the to-be-processed heights is 3. Then, when a vote count threshold is set to half of a total quantity of the management nodes (that is, the vote count threshold is 2), it may be determined that the quantity of the to-be-processed heights greater than or equal to 105 is greater than the vote count threshold, so that it may be determined that the currently confirmed chain height of the service subchain X is 105.

In some embodiments, the M management nodes may include only management nodes of one type. For example, when the M management nodes are all first-type management nodes, correspondingly, a quantity of first voted-for heights is M, so that the target consensus node may invoke the height confirmation method in the subchain control contract to use a first voted-for height having a minimum height in the M first voted-for heights as the target chain height of the target service subchain.

Operation S103: Generate height confirmation information corresponding to the target chain height based on the subchain control contract, and transmit the height confirmation information to a verification node in the target service subnetwork.

After the target consensus node transmits the height confirmation information to the verification node, the verification node writes the target chain height indicated by the height confirmation information into a subchain management contract on the target service subchain.

After obtaining the target chain height of the target service subchain, the target consensus node may place related chain height voting information and the target chain height into a corresponding transaction, and submit the transaction into the subchain control contract for execution. After execution of the transaction succeeds, a confirmed chain height on the target service subchain is the target chain height.

For example, the target consensus node may construct a height confirmation transaction based on the foregoing chain height voting information and the target chain height. For example, the chain height voting information and the target chain height may be packaged into the height confirmation transaction based on a transaction format associated with the target chain. The target consensus node may package the height confirmation transaction into a target block of the target chain when a transaction packaging condition associated with the target chain is satisfied, and submit the target block including the height confirmation transaction onto the target chain. Subsequently, the target consensus node may invoke the subchain control contract on the target chain to execute the height confirmation transaction in the target block, to obtain the height confirmation information corresponding to the target chain height. Finally, the target consensus node may transmit the height confirmation information to the verification node in the target service subnetwork through a target cross-chain relay, to cause the verification node to write the target chain height corresponding to the height confirmation information into a subchain management contract on the target service subchain. The subchain management contract is configured to instruct the verification node to determine, based on the target chain height, the chain height obtained after execution of the target service requested by the service object. The foregoing target cross-chain relay may be configured to isolate the target service subnetwork and the target chain network, and can provide a cross-chain service between the target service subnetwork and the target chain network. When receiving the height confirmation information transmitted by the target consensus node, the target cross-chain relay may package, according to a cross-chain data format configured by the target cross-chain relay, content (such as the target chain height) extracted from the height confirmation information into a cross-chain message in the cross-chain data format, and then forward the cross-chain message carrying the target chain height to the verification node in the target service subnetwork.

Since the target service subchain is created after the service object applies in the subnet management contract on the target chain, and a genesis block of the target service subchain is managed by the target chain. The genesis block includes the subchain management contract. Therefore, when the target service subchain is started, the subchain management contract may be built in the genesis block of the target service subchain, to ensure that the target service subchain is to be subject to statement management and remote control by the subchain control contract on the target chain.

Each piece of chain height voting information of the management node for the target service subchain is processed by the target consensus node, but is not necessarily submitted to the target chain. In other words, the target consensus node may collect chain height voting information generated by the management node, and calculate the target chain height of the target service subchain based on the obtained chain height voting information. However, only when a set transaction packaging condition is satisfied, the target consensus node submits the relevant chain height voting information and the corresponding target chain height onto the target chain together. The transaction packaging condition herein may be configured by the target chain. For example, when a specific transaction service (for example, a configuration service for performing related configuration on the first chain, the second chain, or another service subchain different from the target service subchain) is run on the target chain, or when empty blocks are periodically produced on the target chain, it may be considered that the transaction packaging condition is satisfied. In this case, the target consensus node may package the height confirmation transaction into a target block and submit the target block onto the target chain.

In some embodiments, it may be considered that height confirmation by the target consensus node on the target service subchain is not performed immediately, and instead, there is an asynchronous time. According to a configuration in the target chain, the target service subchain may include H blocks more than the target chain height (for example, the chain height k) confirmed on the target chain. To be specific, when the target chain confirms the chain height k on the target service subchain, the target service subchain may continue executing a target service requested by a service object, to continue accumulating H blocks based on the chain height k. In other words, the verification node in the target service subnetwork may determine, based on the target chain height of the target service subchain confirmed by the target chain, a chain height obtained after execution of the target service.

The target block is a block to be added to the target chain. Therefore, after producing the target block including the height confirmation transaction, the target consensus node may transmit the target block to the remaining target consensus nodes in the target chain network, to cause the remaining target consensus nodes perform block verification on the target block, to obtain a block verification result corresponding to the target block (including executing the height confirmation transaction in the target block, to obtain a transaction execution result corresponding to the height confirmation transaction). The remaining target consensus nodes herein refer to remaining consensus nodes, other than the target consensus node, in the target chain network. The target consensus node may receive the block verification result returned by the remaining target consensus nodes. If the block verification result indicates that the block verification succeeds (for example, all obtained transaction execution results are consistent), the target block may be written into the target chain. In this case, the target consensus node may invoke the subchain control contract on the target chain to execute the height confirmation transaction in the target block, to obtain the height confirmation information corresponding to the target chain height. The height confirmation information includes the target chain height.

In addition, when finding that a service risk exists on the target service subchain, the management node may cast a negative vote for a corresponding risk height, and the negative vote is immediately submitted to the target chain for processing. For example, it is assumed that the chain height voting information includes second-type height voting information of the management node for the target service subchain. The second-type height voting information herein is voted-against information. To be specific, the second-type height voting information is chain height voting information generated when the management node detects that a service risk exists on the target service subchain and votes against a chain height (or a risk height) in which the service risk is located. For example, assuming that a management node W performs voting on a service subchain X, and may vote, when finding that a service risk exists on a chain height k of the service subchain X, against the chain height k (that is, cast a negative vote for the chain height k), correspondingly obtained chain height voting information is second-type height voting information (or voted-against information). The service risk may be a risk or an error of service resource data in the target service subchain. The service resource data herein may include, but is not limited to, resource data transferred from the first chain or the second chain across chains and associated with the target service, contract parameters and contract states associated with smart contracts (such as a subchain management contract and a subchain service contract) deployed on the target service subchain, a related service execution result, transaction data, and a read/write dataset obtained after executing the target service, and the like. For example, in a service scenario related to an electronic bill, a service risk on the target service subchain may be: Sensitive information exists in an electronic bill associated with the subchain service, or an error (for example, an error in a tax number or an error in title information) exists in bill information in the electronic bill. A quantity of electronic bills issued by a specific bill issuance enterprise within a specific time period reaches a bill issuance count threshold. An error occurs in some contract parameters in a bill statistics contract configured for counting a quantity of electronic bills, or an error occurs in a bill statistics result obtained by executing a bill statistics service, and so on.

The second-type height voting information may include a voted-against height obtained when the management node votes against a chain height (or a risk height) of the target service subchain, and the second-type height voting information belongs to a first risk handling transaction determined by the management node based on a risk transaction. The risk transaction is generated by the management node based on the voted-against height. In other words, after detecting a service risk, the management node may use a chain height at which the service risk is located as a voted-against height, generate a risk transaction based on the voted-against height, and then, determine, based on the risk transaction, a first risk handling transaction configured to be transmitted to the target consensus node. The first risk handling transaction may be configured to indicate a corresponding risk transaction, a voted-against height, and a service risk. For example, in a service scenario related to an electronic bill, when finding that an error exists in a tax number in an electronic bill on the target service subchain, the management node may use a block height corresponding to a block in which the electronic bill is located as a voted-against height, and record the voted-against height and the tax number of the erroneous electronic bill by generating a corresponding risk transaction.

When obtaining the first risk handling transaction transmitted by the management node, the target consensus node may write the risk transaction indicated by the first risk handling transaction into the subchain control contract, determine a chain height greater than the voted-against height on the target service subchain as an invalid chain height, and generate subchain locking information associated with the risk transaction. In other words, the target chain may record the risk transaction indicated by the first risk handling transaction based on the subchain control contract, and generate subchain locking information associated with the risk transaction. Subsequently, the target consensus node may transmit the subchain locking information to the verification node in the target service subnetwork through a target cross-chain relay. The target cross-chain relay may generate a cross-chain event based on content of the subchain locking information, and then, forward the cross-chain event carrying the subchain locking information to the verification node.

Correspondingly, when receiving the subchain locking information, the verification node stops executing a risk service (for example, a bill statistics service related to the erroneous electronic bill) associated with the risk transaction, and may perform, when receiving a second risk handling transaction submitted by a service management object associated with the target service subnetwork, risk elimination (for example, eliminating risky or erroneous service resource data, rolling back, or withdrawing service authority (such as bill issuance authority) of a related user or object) on the risk service based on the second risk handling transaction. In addition, the subchain locking information is further configured to instruct the verification node in the target service subnetwork to set a service state of the target service subchain to a locked state. In this case, the target service subchain in the locked state stops transaction chaining, and stops performing cross-chain interaction with the first chain (such as the foregoing bill chain) and the second chain (such as the foregoing application contract chain) included in the multi-blockchain. In other words, when being locked, the target service subchain cannot generate a new block, and cannot accept a data cross-chain request from the first chain or the second chain. That is, when the target service subchain is locked, a related service state cannot be transferred across chains to the first chain or the second chain for use, and required related cross-chain assets (such as bill assets) cannot be transferred back to the target service subchain either. Both the first chain and the second chain are blockchains different from the target service subchain.

The service management object is an entity object that can manage a service risk on the target service subchain (for example, a personal user, an enterprise user, or an institution that applies to the target chain to manage a service risk on the target service subchain). The entity object has an administrator account for the target service subchain. Authority of the service management object is higher than authority of an ordinary service object. In other words, after the foregoing risk transaction occurs, the target service subchain enters a locked state. In this case, only a second risk handling transaction generated by the service management object based on the service risk existing on the target service subchain can be submitted to the target service subchain, and other service transactions cannot be submitted to the target service subchain (chaining of the other service transactions may be rejected based on the subchain management contract on the target service subchain).

When the foregoing risk service is successfully handled, the service management object may transmit, to the target consensus node, a risk release transaction configured for requesting to release the risk transaction. The target consensus node may invoke the subchain control contract to execute the risk release transaction, to obtain risk release information configured for releasing the risk transaction, and may transmit the risk release information to the verification node in the target service subnetwork through the target cross-chain relay, to cause the verification node to use the foregoing voted-against height (for example, the chain height k) as the target chain height of the target service subchain, and also restore the service state of the target service subchain from the locked state to an unlocked state. In this case, the target service subchain can resume executing transaction chaining, that is, can resume chaining of normal service transactions. In addition, when detecting that the risk release information exists on the target service subchain, the management node may consider that the voted-against height (for example, the chain height k) indicated by the risk transaction and the service risk at the chain height before the voted-against height have been processed, and may perform voting starting from a block corresponding to a chain height (for example, a chain height k+1) next to the target chain height (that is, continue to perform management logic and voting starting from the chain height k+1). In view of the above, through the foregoing voted-against and risk handling procedures, a relevant department (such as a taxation management department) may strictly and flexibly complete risk handling, and the blockchain system service can be automatically restored after the risk is successfully handled.

The second-type height voting information also includes signature information (which may also be referred to as second signature information) of the management node. The signature information of the management node is obtained by the management node by performing signature addition on the voted-against height based on private key information of the management node. Therefore, when obtaining the second-type height voting information, the target consensus node also needs to first perform signature verification on the signature information in the second-type height voting information, and then, perform subsequent related risk handling when the signature verification succeeds. The signature verification process herein is similar to the foregoing process in which the target consensus node performs signature verification on the signature information in the first-type height voting information. Details are not described herein again.

An asynchronous voting confirmation mechanism is adopted in this embodiment of the present disclosure. To be specific, the target chain does not immediately confirm the first-type height voting information (or the voted-for information) for the target service subchain, and instead, an asynchronous time is configured in the subchain control contract. In this way, it can be ensured that the management node and the target consensus node do not need to be fully synchronized with the target service subchain in real time, thereby ensuring that management confirmation on the target service subchain does not affect real-time service performance of the target service subchain. However, the target chain immediately submits the second-type height voting information (or the voted-against information) for the target service subchain for processing, which can ensure that a service risk is quickly handled, thereby improving risk handling efficiency of the blockchain system, and maintaining normal operation of the target service subchain to a maximum extent (that is, reducing a time during which the target service subchain is in the locked state).

In this embodiment of the present disclosure, voting confirmation is performed on the chain height of the target service subchain through transitive voting, and the management node does not need to perform voting on each chain height on the target service subchain. For example, assuming that the management node 41a in FIG. 4 performs voting on the service subchain 1, a chain height (which may be referred to as a first-time confirmation height) on which the management node 41a performs voting confirmation for the service subchain 1 at a first voting timestamp (such as a timestamp T3) is 100, and a chain height (which may be referred to as a second-time confirmation height) on which the management node 41a performs voting confirmation for the service subchain 1 at a second voting timestamp (such as a timestamp T4) is 105, the management node 41a confirms all chain heights between 101 and 105, that is, confirms service resource data (such as transaction data and a service execution result in the block) related to blocks corresponding to the chain heights. The second voting timestamp is a voting timestamp next to the first voting timestamp, and a time interval between the second voting timestamp and the first voting timestamp is a voting time interval (for example, 1 minute) configured by the management node 41a. In other words, the management node 41a may perform voting on some chain heights of the service subchain 1 based on the voting time interval configured by the management node 41a. Correspondingly, when the target consensus node confirms a specific chain height (for example, the chain height of 100) on the target service subchain, the target consensus node confirms all chain heights before the chain height (that is, the chain heights before the chain height of 100). In view of the above, the management node may confirm a plurality of consecutive blocks of a plurality of service subchains (such as the target service subchain) at a time according to a voting time interval configured by the management node. Therefore, frequent height confirmation transactions on the target chain can be avoided, thereby improving high confirmation efficiency.

Based on this, when querying service resource data on the target service subchain across chains, the foregoing service object or an external service party associated with a related service (such as a bill service or a bill derivative service) may query, according to whether management confirmation is needed, the target chain and verify whether a chain height at which the service resource data is located that the service object or the external service party needs to query is a confirmed chain height on the target service subchain. For example, the service object may transmit a subchain data query request (which may be referred to as a first subchain data query request) to the target consensus node through the service terminal. When obtaining the subchain data query request, the target consensus node may read the target chain height of the target service subchain based on the subchain control contract (which may be a height reading method in the subchain control contract), and may compare a to-be-verified chain height indicated by the subchain data query request with the read target chain height, to obtain a corresponding comparison result. The target consensus node may generate, when the comparison result indicates that the to-be-verified chain height is less than or equal to the target chain height, subchain query response information corresponding to the subchain data query request, and return the subchain query response information to the service terminal. The subchain query response information is configured to indicate that the to-be-verified chain height queried by the service object is a confirmed chain height on the target service subchain. In this way, the service object can trust correctness and reliability of a related service execution result at the to-be-verified chain height, and therefore, may request, through the service terminal, the target service subchain to obtain some service resource data (for example, some authorized-to-be-visible bill information in a related electronic bill) at the to-be-verified chain height. Otherwise, when the comparison result indicates that the to-be-verified chain height is greater than the target chain height, the to-be-verified chain height queried by the service object is an unconfirmed chain height on the target service subchain, and there is a possibility of a service risk. In this case, the target consensus node may transmit, to the service terminal, subchain query failure information configured to indicate that the to-be-verified chain height is an unconfirmed chain height on the target service subchain.

In some embodiments, when receiving the subchain data query request, the target consensus node may also directly return the target chain height of the target service subchain read from the target chain to the service terminal, and the service terminal compares the target chain height with the to-be-verified chain height.

In some embodiments, the management node may also synchronously back up a chain height (such as the foregoing target chain height) confirmed by the target chain each time. Therefore, the service object may also transmit a second subchain data query request to the management node through the service terminal, to query the management node and verify whether the chain height at which the service resource data that needs to be queried is located is a confirmed chain height on the target service subchain. A verification process performed by the management node is similar to the verification process performed by the foregoing target consensus node. Details are not described herein again.

After execution of the target service is completed, the target service subnetwork is offline and shut down, and the related management node also exits management on the target service subchain.

In an application of this embodiment of the present disclosure, for any service subchain (such as the foregoing target service subchain) created in a multi-blockchain architecture, a management node that needs to manage the service subchain may perform identity registration in a subchain control contract as a corresponding registered node (such as the foregoing target registered node) and may flexibly customize management logic thereof for the service subchain. In addition, flexible management may be implemented on any service subchain in the multi-blockchain architecture based on the subchain control contract deployed on the target chain and the management logic customized by the management node. Besides, since both the target chain and the management node are independent of the service subchain, and management confirmation is performed on the service subchain by using an asynchronous voting confirmation mechanism, related subchain services can still be executed orderly on the service subchain, which does not affect independent operation and real-time service performance of the service subchain. In addition, a transitive voting implementation adopted in this embodiment of the present disclosure can effectively support the management node in completing confirmation in batches, and reduce height confirmation transactions on the target chain, thereby improving performance of the entire blockchain system and saving storage space.

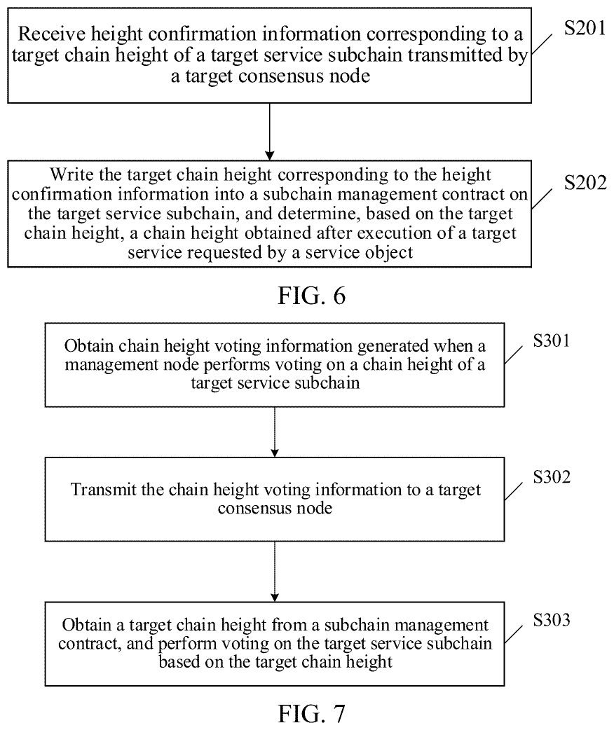

Referring to FIG. 6, FIG. 6 is a schematic flowchart of a data processing method for a multi-blockchain according to an embodiment of the present disclosure. As shown in FIG. 6, the method may be performed by a verification node in a target service subnetwork. For example, the verification node may be any verification node in the service subnetwork 500a shown in FIG. 1. The method may include the following operation S201 to operation S202.

Operation S201: Receive height confirmation information corresponding to a target chain height of a target service subchain transmitted by a target consensus node.

After a target service subnetwork is started, a verification node in the target service subnetwork may execute, based on a subchain service contract deployed on the target service subchain, a target service requested by a service object, so that based on an obtained service execution result, new blocks can be continuously produced and added to the target service subchain. In this process, a management node of a target chain may manage the target service subchain based on service logic set on the target chain, and may confirm a chain height of the target service subchain through transitive voting and feed back a service risk timely.

The verification node in the target service subnetwork may receive, through a target cross-chain relay, height confirmation information transmitted by the target consensus node. The height confirmation information may be configured to indicate the target chain height of the target service subchain. The height confirmation information is generated by the target consensus node based on a subchain control contract configured for controlling the target service subchain and deployed on the target chain. The target chain height of the target service subchain is determined by the target consensus node based on obtained chain height voting information of a management node associated with the target chain for the target service subchain, a voting type of the chain height voting information, and a subchain control contract. The subchain control contract includes a target registered node performing identity registration for the target service subchain. The voting type of the chain height voting information is determined based on a node registration identity of the target registered node when the target consensus node determines, based on the subchain control contract, that the management node is a target registered node. For a process in which the target consensus node generates the height confirmation information, reference may be made to the embodiment corresponding to FIG. 5. Details are not described herein again.

Operation S202: Write the target chain height corresponding to the height confirmation information into a subchain management contract on the target service subchain, and determine, based on the target chain height, a chain height obtained after execution of the target service requested by the service object.

For example, the verification node may write the target chain height corresponding to the height confirmation information into the subchain management contract. The subchain management contract is a smart contract deployed, when the target service subchain is started, based on a genesis block of the target service subchain obtained from the target chain, so that it can be ensured that the target service subchain is managed and controlled by the subchain control contract on the target chain. In addition, the verification node may obtain a buffer height synchronized from the target chain. In some embodiments, when receiving the height confirmation information, the verification node may request the target chain for synchronizing a corresponding buffer height. Alternatively, the buffer height may be included in the height confirmation information and delivered to the verification node. Alternatively, in a case that the buffer height is not adjusted or updated, the verification node may obtain a previously stored buffer height from a local cache. Subsequently, the verification node may use a sum of the buffer height and the target chain height as a block production height threshold. For example, when the buffer height is F (F is a positive integer) and the target chain height is k, a corresponding block production height threshold is equal to (F+k).

The verification node may invoke the subchain service contract on the target service subchain to execute the target service requested by the service object, to obtain a target service execution result, may produce a proposal block with a target block height based on the target service execution result, and may perform chaining on the proposal block. All verification nodes in the target service subnetwork need to perform block consensus on the proposal block, and can add the proposal block to the target service subchain only when the block consensus is reached. In this case, the verification node may determine, based on the target block height and the block production height threshold, a chain height obtained after execution of the target service, where the target block height is greater than the target chain height and less than or equal to the block production height threshold. For example, using a service subchain X as an example, assuming that a corresponding buffer height thereof is set to F, and a currently confirmed target chain height is k, in a case that the service subchain X has confirmed the chain height k, the service subchain X can still continue cumulatively producing blocks at the chain height k to a chain height of (F+k). When the chain height of the service subchain X reaches (F+k) (that is, the block production height threshold), if no chain height after k is confirmed on the target chain, a subchain management contract on the service subchain X rejects any other transaction from being chained until more chain heights on the service subchain X are confirmed.

For example, in this embodiment of the present disclosure, a chain height that is on the target service subchain (for example, the foregoing service subchain X) and that is located after the target chain height (for example, the chain height k) may be as a to-be-confirmed chain height. When the to-be-confirmed chain height reaches the block production height threshold (for example, F+k), and updated height confirmation information from the target consensus node for the to-be-confirmed chain height is not obtained, the verification node may set, based on the subchain management contract on the target service subchain, a service state of the target service subchain to a locked state. In this case, the target service subchain in the locked state stops performing transaction chaining. In some embodiments, if obtaining the updated height confirmation information transmitted by the target consensus node for the to-be-confirmed chain height, the verification node may write the to-be-confirmed chain height corresponding to the updated height confirmation information into the subchain management contract, and restore the service state of the target service subchain from the locked state to an unlocked state. In this case, the target service subchain may continue executing the target service and continue cumulatively produce blocks at a chain height corresponding to the updated height confirmation information. In some embodiments, the chain height confirmed by the foregoing updated height confirmation information may alternatively be any chain height after the target chain height, for example, may be a chain height between the target chain height and the block production height threshold, or may be a chain height greater than the block production height threshold.

The foregoing buffer height may be configured by the target chain. Generally, for seamless service connection, a value of the buffer height is set to be large, and may be dynamically adjusted based on a traffic situation. The value of the buffer height is not limited in this embodiment of the present disclosure. The asynchronous voting confirmation mechanism can be implemented by setting the buffer height, thereby ensuring that the management node and the target consensus node do not need to be completely synchronized with the service subchain in real time. In this way, even if the target chain has not confirmed some chain heights on the service subchain, real-time service performance of the service subchain is not affected within a short time.

In addition, when the management node finds that there is a service risk on the target service subchain, the verification node may also perform related risk handling together with the target consensus node. For example, it is assumed that the chain height voting information includes second-type height voting information. Based on this, when receiving subchain locking information transmitted by the target consensus node, the verification node may stop executing a risk service associated with the foregoing risk transaction based on the subchain locking information, and may set a service state of the target service subchain to a locked state. In this case, the target service subchain in the locked state stops transaction chaining and stops performing cross-chain interaction with a first chain and a second chain included in the multi-blockchain. Both the first chain and the second chain are blockchains different from the target service subchain. The subchain locking information is obtained after the target consensus node writes a risk transaction indicated by a first risk handling transaction into the subchain control contract.

When receiving a second risk handling transaction submitted by a service management object associated with the target service subnetwork, the verification node may perform risk elimination on a risk service based on a second risk handling transaction, and return risk handling success information to the service management object when risk service handling succeeds. The risk handling success information herein is configured to instruct the service management object to transmit a risk release transaction to the target consensus node when the risk service is successfully handled, where the risk release transaction is configured to instruct the target consensus node to generate, based on the subchain control contract, risk release information for releasing the risk transaction. The verification node may receive the risk release information returned by the target consensus node, use the voted-against height as the target chain height of the target service subchain based on the risk release information, and restore the service state of the target service subchain from the locked state to an unlocked state. For a related risk handling process performed by the target consensus node, reference may be made to operation S104 in the embodiment corresponding to FIG. 5. Details are not described herein again.

In this embodiment of the present disclosure, flexible management may be implemented on any service subchain in the multi-blockchain architecture based on the subchain control contract on the target chain and the management logic (service logic) customized by the management node. Besides, since both the target chain and the management node are independent of the service subchain, and management confirmation is performed on the service subchain by using an asynchronous voting confirmation mechanism, related subchain services can still be executed orderly on the service subchain. That is, the service subchain management solution provided in this embodiment of the present disclosure does not affect independent operation of the service subchain.

Referring to FIG. 7, FIG. 7 is a schematic flowchart of a data processing method for a multi-blockchain according to an embodiment of the present disclosure. As shown in FIG. 7, the method may be performed by a management node associated with the target chain. For example, the management node may be any management node in the management node cluster shown in FIG. 4. The method may include the following operation S301 to operation S303.

Operation S301: Obtain chain height voting information generated when the management node performs voting on a chain height of a target service subchain.

When expecting to manage the target service subchain, the management node needs to perform identity registration in the subchain control contract deployed on the target chain. For example, the management node transmits a subchain management request configured to request to manage the target service subchain to the target consensus node. The subchain management request may include registered node information (such as a node identifier of the management node, a node registration identity whose registration is applied for the target service subchain, a chain identifier of the target service subchain that management node expects to manage, and management logic for the target service subchain) of the management node. When receiving the subchain management request, the target consensus node may obtain the registered node information in the subchain management request, and may invoke a subchain control contract on the target chain to perform identity registration for the registered node information submitted by the management node. After the registration succeeds, the target consensus node may configure a corresponding public key certificate for the management node, and the management node whose registration succeeds is recorded as a registered node in the subchain control contract.

After performing identity registration with the subchain control contract deployed on the target chain, the management node may perform voting on the target service subchain based on management logic thereof, to obtain chain height voting information generated when performing voting on a chain height of the target service subchain. The subchain control contract is configured for controlling the target service subchain, and the subchain control contract includes a target registered node performing identity registration for the target service subchain.

The management node may flexibly customize management logic thereof. The management logic may include a voting time interval, a voting confirmation manner, a service risk handling manner, and the like that the management node configures for the target service subchain. That the management node performs voting on the target service subchain based on the management logic may include: When obtaining a to-be-confirmed block on the target service subchain, block verification is performed on the to-be-confirmed block based on the management logic configured by the management node, to obtain a block verification result. When the block verification result indicates that the block verification succeeds, a block height corresponding to the to-be-confirmed block may be used as a current voted-for height of the management node. In other words, the management node votes for the block height corresponding to the to-be-confirmed block. Otherwise, when the block verification result indicates that the block verification fails (that is, it is detected that there is a service risk in the to-be-confirmed block), a block height corresponding to the to-be-confirmed block may be used as a current voted-against height of the management node. In other words, the management node votes against the block height corresponding to the to-be-confirmed block. Then, the management node may use the voted-for height or the voted-against height as a voting result of the management node for the to-be-confirmed block, perform signature addition on the voting result based on private key information of the management node, to obtain signature information of the management node, and then generate chain height voting information for the target service subchain based on the obtained voting result and the signature information.

To obtain the to-be-confirmed block, the management node may transmit a data synchronization request to the verification node in the target service subnetwork. The data synchronization request is configured to instruct the verification node to transmit the to-be-confirmed block to the management node. This process involves verification performed by the verification node on the data synchronization request. For example, signature verification is performed on signature information of the management node carried by the data synchronization request, and only when the signature verification succeeds, the to-be-confirmed block is returned to the management node. The to-be-confirmed block herein is a block has not been confirmed by the target chain. For example, the to-be-confirmed block may be a block having a maximum block height on the current target service subchain.

The block verification performed on the to-be-confirmed block may include verification on an identity of a related block production node (that is, a verification node producing the to-be-confirmed block), verification on content of the to-be-confirmed block, for example, verification on a Merkle tree root in the to-be-confirmed block, verification on transaction data associated with the Merkle tree root in the to-be-confirmed block, verification on a parent block hash value in a block header of the to-be-confirmed block, and the like, and may further include conflict detection, risk detection, and the like on the to-be-confirmed block.

The management node does not need to perform voting on each chain height on the target service subchain, and instead, may perform voting confirmation on a chain height of the target service subchain through transitive voting, so that the management node can implement confirmation in batches, thereby improving high confirmation efficiency.

In addition, when detecting that there is a service risk in the to-be-confirmed block, the management node may generate a risk transaction based on the corresponding voted-against height, and may transmit a first risk handling transaction to the target consensus node based on the risk transaction. Finally, the service risk may be handled through the target consensus node and the verification node. For a process thereof, reference may be made to operation S104 in the embodiment corresponding to FIG. 5. Details are not described herein again.

Operation S302: Transmit the chain height voting information to the target consensus node.

The management node may transmit the obtained chain height voting information to the target consensus node, so that the target consensus node can determine a target chain height of the target service subchain based on the chain height voting information. For a process thereof, reference may be made to the embodiment corresponding to FIG. 5. Details are not described herein again.

Operation S303: Obtain the target chain height from the subchain management contract, and perform voting on the target service subchain based on the target chain height.

After the verification node writes the target chain height corresponding to the height confirmation information into the subchain management contract on the target service subchain, the management node may transmit a chain height obtaining request to the verification node. The chain height obtaining request is configured to instruct the verification node to return the target chain height obtained from the subchain management contract to the management node, so that the management node can continue performing voting on the target service subchain based on the confirmed target chain height.

A life cycle, such as joining and exiting, of the management node is completely managed in the target chain. In addition, the management node may freely select a subchain service that the management node expects to manage, flexibly customize management logic thereof, does not need to perform strict synchronization of subchain ledger data, and can join a management service cluster by implementing only a voting interface, and a one-vote veto-type management node and an ordinary-type management node can be distinguished according to according to different management roles. Besides, the asynchronous voting confirmation mechanism adopted in this embodiment of the present disclosure ensures that management confirmation does not affect real-time service performance of the service subchain. In addition, a transitive voting implementation adopted in this embodiment of the present disclosure can effectively support the management node in completing confirmation in batches, and reduce height confirmation transactions on the target chain, thereby improving performance of the entire blockchain system and saving storage space. In addition, using the foregoing voted-against and risk handling procedures provided in this embodiment of the present disclosure, a relevant department may strictly and flexibly complete risk handling, and the blockchain system service can be automatically restored after the risk handling.

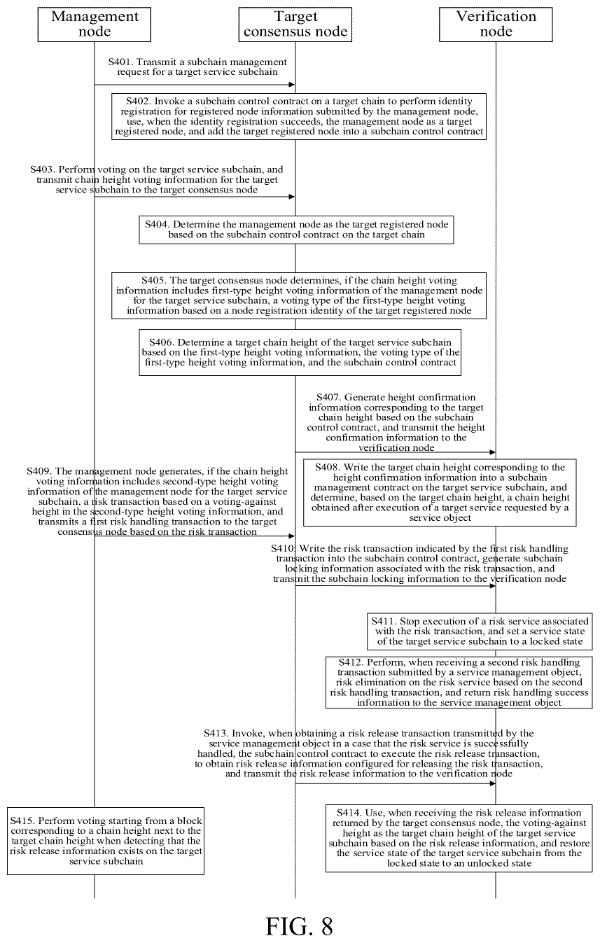

Referring to FIG. 8, FIG. 8 is a schematic diagram of an interaction procedure of a multi-blockchain data processing method according to an embodiment of the present disclosure. As shown in FIG. 8, the method may be jointly performed by the management node, the target consensus node in the target chain network, and the verification node in the target service subnetwork. The method includes:

Operation S401: The management node transmits a subchain management request for a target service subchain to the target consensus node.

The subchain management request includes registered node information of the management node.

Operation S402: The target consensus node invokes, when receiving the subchain management request, a subchain control contract on the target chain to perform identity registration for the registered node information submitted by the management node, uses, when the identity registration succeeds, the management node as a target registered node, and adds the target registered node into the subchain control contract.

Operation S403: The management node performs voting on the target service subchain after the identity registration succeeds, and transmits chain height voting information for the target service subchain to the target consensus node.

Operation S404: The target consensus node determines, when receiving the chain height voting information, the management node as the target registered node based on the subchain control contract on the target chain.

Operation S405: The target consensus node determines, if the chain height voting information includes first-type height voting information of the management node for the target service subchain, a voting type of the first-type height voting information based on a node registration identity of the target registered node.

Operation S406: The target consensus node determines a target chain height of the target service subchain based on the first-type height voting information, the voting type of the first-type height voting information, and the subchain control contract.

Operation S407: The target consensus node generates height confirmation information corresponding to the target chain height based on the subchain control contract, and transmits the height confirmation information to the verification node.

Operation S408: The verification node writes the target chain height corresponding to the height confirmation information into a subchain management contract on the target service subchain, and determines, based on the target chain height, a chain height obtained after execution of the target service requested by the service object.

Operation S409: If the chain height voting information includes second-type height voting information of the management node for the target service subchain, the management node generates a risk transaction based on a voted-against height in the second-type height voting information, and transmits a first risk handling transaction to the target consensus node based on the risk transaction.

Operation S410: The target consensus node writes the risk transaction indicated by the first risk handling transaction into the subchain control contract, generates subchain locking information associated with the risk transaction, and transmits the subchain locking information to the verification node.

Operation S411: The verification node stops execution of a risk service associated with the risk transaction when receiving the subchain locking information, and sets a service state of the target service subchain to a locked state.

Operation S412: When receiving the second risk handling transaction submitted by a service management object, the verification node performs risk elimination on the risk service based on the second risk handling transaction, and returns risk handling success information to the service management object.

Operation S413: When obtaining a risk release transaction transmitted by the service management object in a case that the risk service is successfully handled, the target consensus node invokes the subchain control contract to execute the risk release transaction, to obtain risk release information configured for releasing the risk transaction, and transmits the risk release information to the verification node.

Operation S414: When receiving the risk release information returned by the target consensus node, the verification node uses the voted-against height as the target chain height of the target service subchain based on the risk release information, and restores the service state of the target service subchain from the locked state to an unlocked state.

Operation S415: The management node performs voting starting from a block corresponding to a chain height next to the target chain height when detecting that the risk release information exists on the target service subchain.

Operation S405 to operation S408 and operation S409 to operation S415 are in a parallel relationship, and an execution order of the two parts is not limited in this embodiment of the present disclosure.

When a blockchain is used in some scenarios of a management institution (for example, a taxation system) or a commercial institution, to improve confidentiality and security of data, a hierarchical blockchain structure, “service network-core consensus network”, may be used. For ease of understanding, reference may be made to the network structure of the blockchain electronic bill three-chain network shown in FIG. 2.

In a blockchain electronic bill scenario, a service layer, a routing agent layer, and a core consensus network layer form an entire blockchain service system. The service layer is in a witness network (that is, the service network). Service nodes in the service layer may include a terminal device corresponding to an electronic taxation bureau, a terminal device corresponding to an enterprise user, and a terminal device corresponding to a consumer user. The electronic taxation bureau may be a local taxation bureau in a taxation bureau private network, and the enterprise user may be a bill issuance service provider, a reimbursement service provider, a retail enterprise (for example, a KA enterprise, that is, a large-scale retail customer and a key retail customer enterprise), or the like in a public cloud. The consumer user may be a payment service provider, a circulation service provider, a retail enterprise, or the like in a private cloud. The service nodes in the service network are mainly configured to execute transaction services and do not participate in bookkeeping consensus. When different service objects request to execute different transaction services through corresponding service nodes, the service objects access corresponding core consensus networks, so that related transaction services can be subsequently executed on corresponding blockchains (for example, a bill service is executed on a bill chain).

N relay nodes (that is, routing nodes) in the routing agent layer may be configured to perform network isolation on the service layer and the core consensus network layer. Each relay node may have a point-to-point service (that is, a P2P service), a routing service, a certificate cache, and a certification service. The P2P service refers to a service in a P2P network. Based on a special type of network protocols, network states of network nodes in the P2P network do not need to be maintained by a central node, and instead, each node broadcasts to and interacts with neighboring nodes to maintain node states of the entire network or connection states of its neighboring nodes. The routing service is a basic function of the node, and is configured for communication between nodes. A certificate associated with the certificate cache may be a public key infrastructure (PKI). In the PKI, a certificate is an identity certificate of an owner of a public key and is issued by a certificate authority (CA). The certification service may be configured to perform verification on a data format of received data, node validity, and the like. In this embodiment of the present disclosure, the relay node may forward transaction data generated by the service node to the consensus node.

A consensus node (that is, a bookkeeping node) in the core consensus network layer may be a trusted node in a taxation-dedicated network. Each consensus node has a capability of packaging and producing a block, that is, may package transaction data transmitted by the relay node and produce a block, to successfully write the block into a blockchain in the core consensus network layer.

The core consensus network layer may include a management chain network, a bill chain network, and an application contract chain network. Based on this, the blockchain in the core consensus network layer may be a multi-blockchain including a management chain, a bill chain, and an application contract chain. The service object may apply to the management consensus node in the core consensus network layer through a service node associated with a service terminal for authority to execute a target service (for example, the bill temporary service). The management consensus node is a consensus node in the management chain network included in the core consensus network layer. After obtaining authorization, the service object may apply to a management chain for creation of a target service subnetwork (for example, a service subnetwork A) in the foregoing core consensus network layer, and the target service subnetwork is formed by a first verification node originating from a bill chain network and a second verification node originating from an application contract chain network. Subsequently, through cross-chain interaction between the target service subnetwork and the bill chain network and between the service subnetwork and the application contract chain network, resources associated with the target service may be obtained to execute the target service.

After the target service subnetwork is started, a plurality of management nodes associated with the management chain may manage a target service subchain corresponding to the target service subnetwork. For example, a chain height of the target service subchain is determined through transitive voting, and corresponding risk feedback is performed when it is detected that there is a service risk on the target service subchain.

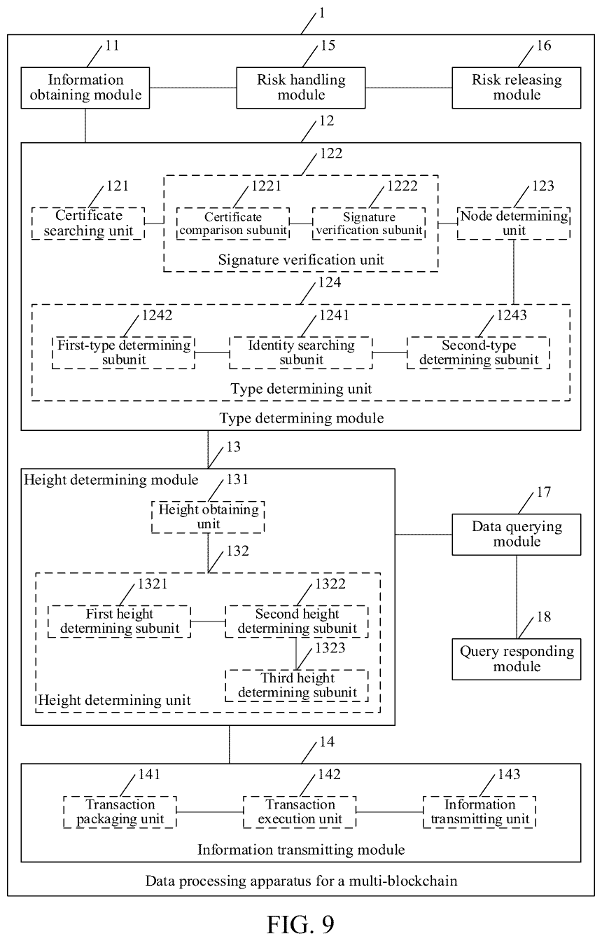

FIG. 9 is a schematic structural diagram of a data processing apparatus for a multi-blockchain according to an embodiment of the present disclosure. The multi-blockchain may include a target chain and a target service subchain. A target chain network corresponding to the target chain herein is independent of a target service subnetwork corresponding to the target service subchain. In addition, the target service subnetwork is constructed by a target consensus node in the target chain network based on a target service requested by a service object. As shown in FIG. 9, a data processing apparatus 1 for a multi-blockchain may be used in a target consensus node. The target consensus node may be any blockchain node in a target chain network (for example, the foregoing consensus network 100a). For example, the target consensus node may be the foregoing consensus node 10a in the embodiment corresponding to FIG. 1. The data processing apparatus 1 for a multi-blockchain may be a computer program (including program code) run on a blockchain node (for example, the foregoing consensus node 10a). For example, the data processing apparatus 1 for a multi-blockchain is application software. The data processing apparatus 1 for a multi-blockchain may be configured to perform the corresponding operations in the data processing method for a multi-blockchain provided in the embodiments of the present disclosure. As shown in FIG. 9, the data processing apparatus 1 for a multi-blockchain may include: an information obtaining module 11, a type determining module 12, a height determining module 13, an information transmitting module 14, a risk handling module 15, a risk releasing module 16, a data querying module 17, and a query responding module 18.

The information obtaining module 11 is configured to obtain chain height voting information of a management node associated with a target chain for a target service subchain. A subchain control contract configured for controlling the target service subchain is deployed on the target chain. The subchain control contract includes a target registered node performing identity registration for the target service subchain.

The type determining module 12 is configured to determine, when determining the management node as the target registered node based on the subchain control contract on the target chain, a voting type of the chain height voting information based on a node registration identity of the target registered node.

In an implementation, the chain height voting information includes first-type height voting information of the management node for the target service subchain. The first-type height voting information includes a node identifier of the management node, a public key certificate of the management node, a voted-for height generated when the management node performs voting on the chain height of the target service subchain, and signature information of the management node. The signature information of the management node is obtained by the management node after performing signature addition on the voted-for height based on private key information of the management node. The subchain control contract includes node registration configuration information of a registered node associated with the target service subchain. The node registration configuration information includes a node identifier of the registered node and a public key certificate of the registered node. The public key certificate of the registered node is obtained after the target consensus node performs, by invoking the subchain control contract, identity registration for registered node information submitted by the registered node.

The type determining module 12 may include a certificate searching unit 121, a signature verification unit 122, a node determining unit 123, and a type determining unit 124.

The certificate searching unit 121 is configured to obtain the node identifier of the management node from the first-type height voting information, search the node identifier of the registered node for a target node identifier the same as the node identifier of the management node, obtain, when finding the target node identifier, a public key certificate of the target registered node corresponding to the target node identifier from the public key certificate of the registered node, and use the obtained public key certificate of the target registered node as a target public key certificate.

The signature verification unit 122 is configured to use the public key certificate of the management node included in the first-type height voting information as a to-be-processed public key certificate, and perform signature verification on the signature information of the management node based on the to-be-processed public key certificate and the target public key certificate, to obtain a signature verification result of the management node.

The signature verification unit 122 may include a certificate comparison subunit 1221 and a signature verification subunit 1222.

The certificate comparison subunit 1221 is configured to use certificate data information in the to-be-processed public key certificate as to-be-processed certificate information, and use certificate data information in the target public key certificate as target certificate information; and compare the to-be-processed certificate information with the target certificate information, to obtain a comparison result.

The signature verification subunit 1222 is configured to perform, in response to the comparison result indicating the to-be-processed certificate information being consistent with the target certificate information, signature verification on the signature information of the management node based on public key information in the to-be-processed public key certificate, and use a verification result obtained when the signature verification succeeds as the signature verification result of the management node.

The node determining unit 123 is configured to determine the management node as the target registered node when the signature verification result of the management node indicates that the signature verification succeeds.

The type determining unit 124 is configured to determine a voting type of the first-type height voting information based on the node registration identity of the target registered node.

In an implementation, the node registration configuration information includes a first-type node registration identity or a second-type node registration identity registered by the registered node for the target service subchain.

The type determining unit 124 may include an identity searching subunit 1241, a first-type determining subunit 1242, and a second-type determining subunit 1243.

The identity searching subunit 1241 is configured to search the node registration configuration information for the node registration identity of the target registered node corresponding to the target node identifier, and use the found node registration identity of the target registered node as a target node registration identity.

The first-type determining subunit 1242 is configured to determine, when the target node registration identity is the first-type node registration identity, based on the first-type node registration identity, that the voting type of the first-type height voting information is a first voting type.

The second-type determining subunit 1243 is configured to determine, when the target node registration identity is the second-type node registration identity, based on the second-type node registration identity, that the voting type of the first-type height voting information is a second voting type.

For implementations of the identity searching subunit 1241, the first-type determining subunit 1242, and the second-type determining subunit 1243, reference may be made to the descriptions of operation S102 in the foregoing embodiment corresponding to FIG. 5. Details are not described herein again.

The height determining module 13 is configured to determine the target chain height of the target service subchain based on the chain height voting information, the voting type of the chain height voting information, and the subchain control contract.

In an implementation, the management node includes a first-type management node and a second-type management node. The first-type management node is a management node registering the first-type node registration identity in the subchain control contract. The second-type management node is a management node registering the second-type node registration identity in the subchain control contract. An identity level of the first-type node registration identity is higher than an identity level of the second-type node registration identity. The chain height voting information includes first-type height voting information of the first-type management node and the second-type management node for the target service subchain. The first-type height voting information may include first chain height voting information of the first voting type determined by the first-type management node based on the first-type node registration identity, and second chain height voting information of the second voting type determined by the second-type management node based on the second-type node registration identity.

The height determining module 13 may include a height obtaining unit 131 and a height determining unit 132.

The height obtaining unit 131 is configured to determine a voted-for height generated when the first-type management node performs voting on the chain height of the target service subchain and included in the first chain height voting information as a first voted-for height, and determine a voted-for height generated when the second-type management node performs voting on the chain height of the target service subchain and included in the second chain height voting information as a second voted-for height.

The height determining unit 132 is configured to invoke, based on the first voted-for height, the subchain control contract to determine a reference voting height threshold for the target service subchain, and determine the target chain height of the target service subchain based on the reference voting height threshold, the first voted-for height, and the second voted-for height.

When a quantity of the first-type management nodes is M1, a quantity of the first voted-for heights is M1, M1 being a positive integer. When a quantity of the second-type management nodes is M2, a quantity of the second voted-for heights is M2, M2 being a positive integer.

The height determining unit 132 may include a first height determining subunit 1321, a second height determining subunit 1322, and a third height determining subunit 1323.

The first height determining subunit 1321 is configured to invoke a height determining method in the subchain control contract to determine a first voted-for height having a minimum height in the M1 first voted-for heights as the reference voting height threshold of the target service subchain.

The second height determining subunit 1322 is configured to obtain voted-for heights less than or equal to the reference voting height threshold from the M1 first voted-for heights and the M2 second voted-for heights, use the obtained voted-for heights as candidate voting heights, and use a voted-for height having a maximum height in the candidate voting heights as a target voted-for height.

The third height determining subunit 1323 configured to use voted-for heights greater than or equal to the target voted-for height in the M1 first voted-for heights and the M2 second voted-for heights as to-be-processed heights, and use the target voted-for height as the target chain height of the target service subchain when detecting, based on the height determining method, that a quantity of the to-be-processed heights is greater than a vote count threshold. The vote count threshold is greater than or equal to (M1+M2)/2.

The information transmitting module 14 is configured to generate height confirmation information corresponding to the target chain height based on the subchain control contract, and transmit the height confirmation information to a verification node in the target service subnetwork, to cause the verification node to write the target chain height corresponding to the height confirmation information into a subchain management contract on the target service subchain. The subchain management contract is configured to instruct the verification node to determine, based on the target chain height, a chain height obtained after execution of the target service requested by the service object.

The information transmitting module 14 may include a transaction packaging unit 141, a transaction execution unit 142, and an information transmitting unit 143.

The transaction packaging unit 141 is configured to construct a height confirmation transaction based on the chain height voting information and the target chain height, package the height confirmation transaction into a target block of the target chain when a transaction packaging condition associated with the target chain is satisfied, and submit the target block including the height confirmation transaction onto the target chain.

The transaction execution unit 142 is configured to invoke the subchain control contract on the target chain to execute the height confirmation transaction in the target block, to obtain the height confirmation information corresponding to the target chain height.

The information transmitting unit 143 is configured to transmit the height confirmation information to the verification node in the target service subnetwork through a target cross-chain relay. The target cross-chain relay is configured to isolate the target service subnetwork and the target chain network.

In an implementation, the chain height voting information includes second-type height voting information of the management node for the target service subchain. The second-type height voting information is determined by the management node when it is detected that a service risk exists on the target service subchain. The second-type height voting information includes a voted-against height of the management node generated when the management node performs voting on the chain height of the target service subchain. The second-type height voting information is in a first risk handling transaction determined by the management node based on a risk transaction. The risk transaction is generated by the management node based on the voted-against height.

The risk handling module 15 is configured to write, when obtaining the first risk handling transaction transmitted by the management node, the risk transaction indicated by the first risk handling transaction into the subchain control contract, determine a chain height greater than the voted-against height on the target service subchain as an invalid chain height, and generate subchain locking information associated with the risk transaction; and transmit the subchain locking information to the verification node on the target service subnetwork to cause the verification node to stop executing a risk service associated with the risk transaction, and perform, when receiving a second risk handling transaction submitted by a service management object associated with the target service subnetwork, risk elimination on the risk service based on the second risk handling transaction. The subchain locking information is further configured to instruct the verification node to set a service state of the target service subchain to a locked state, the target service subchain in the locked state stopping transaction chaining and stopping performing cross-chain interaction with a first chain and a second chain included in the multi-blockchain. Both the first chain and the second chain are blockchains different from the target service subchain.

The risk releasing module 16 is configured to invoke, when obtaining a risk release transaction transmitted by the service management object in a case that the risk service is successfully handled, the subchain control contract to execute the risk release transaction, to obtain risk release information configured for releasing the risk transaction, and transmit the risk release information to the verification node, to cause the verification node to use the voted-against height as the target chain height of the target service subchain and restore the service state of the target service subchain from the locked state to an unlocked state. The management node is configured to perform voting starting from a block corresponding to a chain height next to the target chain height when detecting that the risk release information exists on the target service subchain.

The data querying module 17 is configured to read, when obtaining a subchain data query request transmitted by the service object through a service terminal, the target chain height of the target service subchain based on the subchain control contract, and compare a to-be-verified chain height indicated by the subchain data query request with the read target chain height, to obtain a comparison result.

The query responding module 18 is configured to generate, when the comparison result indicates that the to-be-verified chain height is less than or equal to the target chain height, subchain query response information corresponding to the subchain data query request, and return the subchain query response information to the service terminal. The subchain query response information is configured to indicate that the to-be-verified chain height queried by the service object is a confirmed chain height on the target service subchain.

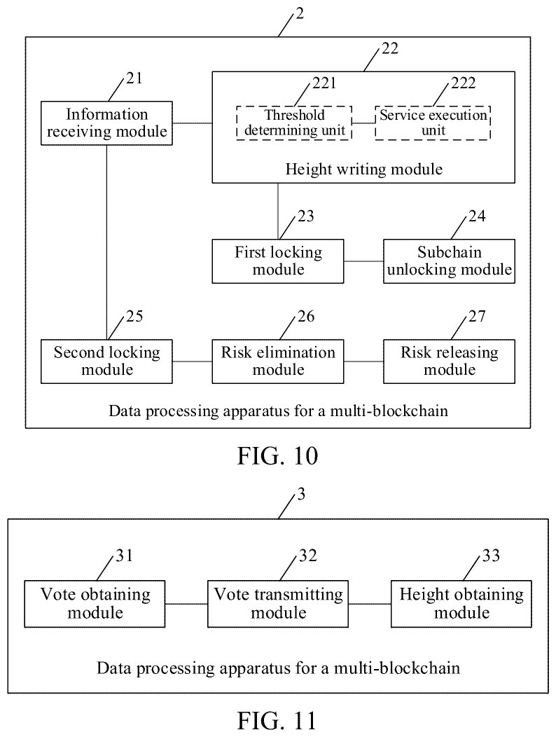

FIG. 10 is a schematic structural diagram of a data processing apparatus for a multi-blockchain according to an embodiment of the present disclosure. The multi-blockchain may include a target chain and a target service subchain. A target chain network corresponding to the target chain herein is independent of a target service subnetwork corresponding to the target service subchain. In addition, the target service subnetwork is constructed by a target consensus node in the target chain network based on a target service requested by a service object. As shown in FIG. 10, a data processing apparatus 2 for a multi-blockchain may be used in a verification node. The verification node may be any blockchain node in a target service subnetwork (for example, the foregoing service subnetwork 500a). For example, the verification node may be the foregoing consensus node 11a in the embodiment corresponding to FIG. 1. The data processing apparatus 2 for a multi-blockchain may be a computer program (including program code) run on a blockchain node (for example, the foregoing consensus node 11a). For example, the data processing apparatus 2 for a multi-blockchain is application software. The data processing apparatus 2 for a multi-blockchain may be configured to perform the corresponding operations in the data processing method for a multi-blockchain provided in the embodiments of the present disclosure. As shown in FIG. 10, the data processing apparatus 2 for a multi-blockchain may include an information receiving module 21, a height writing module 22, a first locking module 23, a subchain unlocking module 24, a second locking module 25, a risk elimination module 26, and a risk releasing module 27.

The information receiving module 21 is configured to receive height confirmation information corresponding to a target chain height of the target service subchain transmitted by the target consensus node. The height confirmation information is generated by the target consensus node based on a subchain control contract configured for controlling the target service subchain and deployed on the target chain. The target chain height of the target service subchain is determined by the target consensus node based on obtained chain height voting information of a management node associated with the target chain for the target service subchain, a voting type of the chain height voting information, and a subchain control contract. The subchain control contract including a target registered node performing identity registration for the target service subchain. The voting type of the chain height voting information is determined based on a node registration identity of the target registered node when the target consensus node determines, based on the subchain control contract, that the management node is a target registered node.

The height writing module 22 is configured to write the target chain height corresponding to the height confirmation information into a subchain management contract on the target service subchain, and determine, based on the target chain height, the chain height obtained after execution of the target service requested by the service object.

The height writing module 22 may include a threshold determining unit 221 and a service execution unit 222.

The threshold determining unit 221 is configured to write the target chain height corresponding to the height confirmation information to the subchain management contract, obtain a buffer height synchronized from the target chain, and use a sum of the buffer height and the target chain height as a block production height threshold.

The service execution unit 222 is configured to invoke a subchain service contract on the target service subchain to execute the target service requested by the service object, to obtain a target service execution result, generate a proposal block with a target block height based on the target service execution result, and determine, based on the target block height and the block production height threshold, a chain height obtained after execution of the target service. The target block height is greater than the target chain height, and the target block height is less than or equal to the block production height threshold.

For implementations of the threshold determining unit 221 and the service execution unit 222, reference may be made to the descriptions of operation S202 in the foregoing embodiment corresponding to FIG. 6. Details are not described herein again.

The first locking module 23 is configured to use a chain height that is on the target service subchain and that is located after the target chain height as a to-be-confirmed chain height; and set, based on the subchain management contract, a service state of the target service subchain to a locked state when the to-be-confirmed chain height reaches the block production height threshold and updated height confirmation information from the target consensus node for the to-be-confirmed chain height is not obtained. The target service subchain in the locked state stops transaction chaining.

The subchain unlocking module 24 is configured to write, when obtaining the updated height confirmation information transmitted by the target consensus node for the to-be-confirmed chain height, the to-be-confirmed chain height corresponding to the updated height confirmation information into the subchain management contract, and restore the service state of the target service subchain from the locked state to an unlocked state.

In an implementation, the chain height voting information includes second-type height voting information of the management node for the target service subchain. The second-type height voting information is determined by the management node when it is detected that a service risk exists on the target service subchain. The second-type height voting information includes a voted-against height of the management node generated when the management node performs voting on the chain height of the target service subchain. The second-type height voting information is in a first risk handling transaction determined by the management node based on a risk transaction. The risk transaction is generated by the management node based on the voted-against height.

The second locking module 25 is configured to stop, when receiving subchain locking information transmitted by the target consensus node, execution of a risk service associated with the risk transaction based on the subchain locking information, and set the service state of the target service subchain to the locked state. The target service subchain in the locked state stops transaction chaining and stops performing cross-chain interaction with a first chain and a second chain included in the multi-blockchain. Both the first chain and the second chain are blockchains different from the target service subchain. The subchain locking information is obtained after the target consensus node writes a risk transaction indicated by a first risk handling transaction into the subchain control contract.

The risk elimination module 26 is configured to perform, when receiving a second risk handling transaction submitted by a service management object associated with the target service subnetwork, risk elimination on the risk service based on the second risk handling transaction, and return risk handling success information to the service management object. The risk handling success information is configured to instruct the service management object to transmit a risk release transaction to the target consensus node in a case that the risk service is successfully handled. The risk release transaction is configured to instruct the target consensus node to generate, based on the subchain control contract, risk release information configured for releasing the risk transaction.

The risk releasing module 27 is configured to receive the risk release information returned by the target consensus node, use the voted-against height as the target chain height of the target service subchain based on the risk release information, and restore the service state of the target service subchain from the locked state to an unlocked state.

FIG. 11 is a schematic structural diagram of a data processing apparatus for a multi-blockchain according to an embodiment of the present disclosure. The multi-blockchain may include a target chain and a target service subchain. A target chain network corresponding to the target chain herein is independent of a target service subnetwork corresponding to the target service subchain. In addition, the target service subnetwork is constructed by a target consensus node in the target chain network based on a target service requested by a service object. As shown in FIG. 11, a data processing apparatus 3 for a multi-blockchain may be used in a management node. The management node may be any management node in a management node cluster (for example, the management node cluster in FIG. 4) associated with the target chain. For example, the management node may be the management node 41a in the embodiment corresponding to FIG. 4. The data processing apparatus 3 for a multi-blockchain may be a computer program (including program code) run on a management node (for example, the foregoing management node 41a). For example, the data processing apparatus 3 for a multi-blockchain is application software. The data processing apparatus 3 for a multi-blockchain may be configured to perform the corresponding operations in the data processing method for a multi-blockchain provided in the embodiments of the present disclosure. As shown in FIG. 11, the data processing apparatus 3 for multi-blockchain may include a vote obtaining module 31, a vote transmitting module 32, and a height obtaining module 33.

The vote obtaining module 31 is configured to obtain chain height voting information generated when the management node performs voting on a chain height of the target service subchain. A subchain control contract configured for controlling the target service subchain is deployed on the target chain. The subchain control contract includes a target registered node performing identity registration for the target service subchain.

The vote transmitting module 32 is configured to transmit the chain height voting information to the target consensus node, to cause the target consensus node to determine, when determining the management node as the target registered node based on the subchain control contract, a voting type of the chain height voting information based on a node registration identity of the target registered node, and generate, based on the subchain control contract, height confirmation information corresponding to the target chain height when determining a target chain height of the target service subchain based on the chain height voting information, the voting type of the chain height voting information, and the subchain control contract. The height confirmation information being configured to be transmitted to a verification node in the target service subnetwork. The verification node being configured to write the target chain height corresponding to the height confirmation information into a subchain management contract on the target service subchain. The subchain management contract is configured to instruct the verification node to determine, based on the target chain height, a chain height obtained after execution of the target service requested by the service object.

The height obtaining module 33 is configured to obtain the target chain height from the subchain management contract, and perform voting on the target service subchain based on the target chain height.

The term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

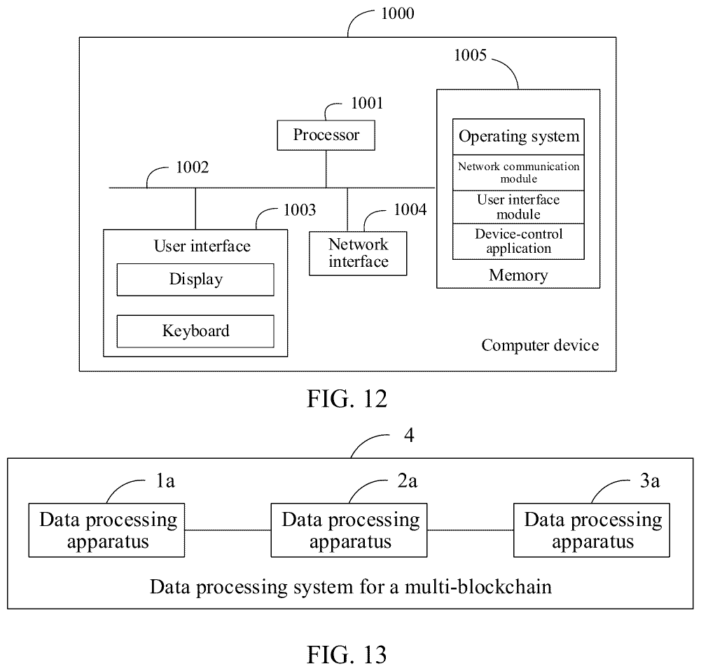

Referring to FIG. 12, FIG. 12 is a schematic structural diagram of a computer device according to an embodiment of the present disclosure. As shown in FIG. 12, a computer device 1000 may include a processor 1001, a network interface 1004, and a memory 1005. In addition, the computer device 1000 may further include a user interface 1003 and at least one communication bus 1002. The communication bus 1002 is configured to implement connection and communication between the components. The user interface 1003 may include a display, a keyboard, and in some embodiments, the user interface 1003 may further include a standard wired interface and a standard wireless interface. In some embodiments, the network interface 1004 may include a standard wired interface or wireless interface (for example, a Wi-Fi interface). The memory 1005 may be a high-speed random access memory (RAM), or may be a non-volatile memory, for example, at least one magnetic disk memory. In some embodiments, the memory 1005 may alternatively be at least one storage apparatus far away from the processor 1001. As shown in FIG. 12, the memory 1005 used as a computer-readable storage medium may include an operating system, a network communication module, a user interface module, and a device-control application.

In the computer device 1000 shown in FIG. 12, the network interface 1004 may provide a network communication function. The user interface 1003 is mainly configured to provide an input interface for a user. The processor 1001 may be configured to invoke the device-control application stored in the memory 1005, to implement the descriptions of the data processing method for a multi-blockchain in the embodiment corresponding to any one of FIG. 5, FIG. 6, FIG. 7, or FIG. 8. Details are not described herein again. In addition, the descriptions of beneficial effects obtained by using the same method are not described herein in detail again.

In addition, the embodiments of the present disclosure further provide a computer-readable storage medium. The computer-readable storage medium has a computer program executed by the data processing apparatus 1 for a multi-blockchain, the data processing apparatus 2 for a multi-blockchain, and the data processing apparatus 3 for a multi-blockchain that are mentioned above, and the computer program includes program instructions. When executing the program instructions, the processor can perform the descriptions of the data processing method for a multi-blockchain in the embodiment corresponding to any one of FIG. 5, FIG. 6, FIG. 7, or FIG. 8. Therefore, details are not described herein again. In addition, the descriptions of beneficial effects obtained by using the same method are not described herein in detail again. For technical details that are not disclosed in the embodiments of the computer-readable storage medium included in the present disclosure, reference may be made to the descriptions about the method embodiments of the present disclosure.

The computer-readable storage medium may be a data processing apparatus for a multi-blockchain or an internal storage unit of the foregoing computer device, for example, a hard drive or a memory of the computer device, provided in any one of the foregoing embodiments. The computer-readable storage medium may alternatively be an external storage device of the computer device, for example, a removable hard drive, a smart memory card (SMC), a secure digital (SD) card, or a flash card equipped on the computer device. The computer-readable storage medium may also include both an internal storage unit and an external storage device of the computer device. The computer-readable storage medium is configured to store the computer program and another program and data that are required by the computer device. The computer-readable storage medium may also be configured to temporarily store data that has been outputted or to-be-outputted data.

In addition, the embodiments of the present disclosure further provide a computer program product or a computer program. The computer program product or the computer program includes computer instructions, and the computer instructions are stored in a computer-readable storage medium. A processor of a computer device reads the computer instructions from the computer-readable storage medium. The processor executes the computer instructions, to cause the computer device to perform the method provided in the embodiment corresponding to any one of FIG. 5, FIG. 6, FIG. 7, or FIG. 8. In addition, the descriptions of beneficial effects obtained by using the same method are not described herein in detail again. For technical details that are not disclosed in the embodiment of the computer program product or computer program of the present disclosure, refer to the method embodiments of the present disclosure.

Referring to FIG. 13, FIG. 13 is a schematic structural diagram of a data processing system for a multi-blockchain according to an embodiment of the present disclosure. A data processing system 4 for a multi-blockchain may include a data processing apparatus 1a, a data processing apparatus 2a, and a data processing apparatus 3a. The data processing apparatus 1a may be the data processing apparatuses 1 for a multi-blockchain in the foregoing embodiment corresponding to FIG. 9, and the data processing apparatus 1a may be integrated into the consensus node 40 in the foregoing embodiment corresponding to FIG. 4. Therefore, details are not described herein again. The data processing apparatus 2a may be the data processing apparatuses 2 for a multi-blockchain in the foregoing embodiment corresponding to FIG. 10, and the data processing apparatus 2a may be integrated into the verification node 42a in the foregoing embodiment corresponding to FIG. 4. Therefore, details are not described herein again. The data processing apparatus 3a may be the data processing apparatuses 3 for a multi-blockchain in the foregoing embodiment corresponding to FIG. 11, and the data processing apparatus 3a may be integrated into the management node 41a in the foregoing embodiment corresponding to FIG. 4. Therefore, details are not described herein again. In addition, the descriptions of beneficial effects obtained by using the same method are not described herein in detail again. For technical details that are not disclosed in the embodiment of the data processing system for a multi-blockchain involved in the present disclosure, reference may be made to the descriptions of the method embodiments in the present disclosure.

In the specification, claims, and accompanying drawings of the present disclosure, the terms “first” and “second” are intended to distinguish between different objects but do not indicate a particular order. In addition, terms, such as “include”, and any variations thereof are intended to indicate non-exclusive inclusion. For example, a process, method, apparatus, product, or device that includes a series of operations or units is not limited to the listed operations or units; and instead, in some embodiments, further includes an operation or unit that is not listed, or in some embodiments, further includes another operation or unit that is intrinsic to the process, method, apparatus, product, or device.

A person of ordinary skill in the art may be aware that, with reference to the exemplary units and algorithm operations described in the embodiments disclosed in this specification, the present disclosure may be implemented by electronic hardware, computer software, or a combination thereof. To clearly describe interchangeability between the hardware and the software, the exemplary compositions and operations have been generally described according to functions in the foregoing descriptions. Whether the functions are performed by hardware or software depends on particular applications and design constraint conditions of the technical solutions. A person skilled in the art may use different methods to implement the described functions for each particular application, but such implementation is not to be considered as going beyond the scope of the present disclosure.

Disclosed above are merely exemplary embodiments of the present disclosure, and are certainly not intended to limit the patent scope of the present disclosure. Therefore, an equivalent change made according to the claims of the present disclosure still falls within the scope of the present disclosure.

What is claimed is:

1. A data processing method for a multi-blockchain, the multi-blockchain comprising a target chain and a target service subchain, a target chain network corresponding to the target chain being independent of a target service subnetwork corresponding to the target service subchain, the target service subnetwork being constructed by a target consensus node in the target chain network based on a target service requested by a service object, the method being performed by the target consensus node, and the method comprising:
obtaining chain height voting information of a management node of the target chain for the target service subchain, wherein a subchain control contract configured for controlling the target service subchain is deployed on the target chain, the subchain control contract comprises a target registered node performing identity registration for the target service subchain;
determining, in response to determining the management node as the target registered node based on the subchain control contract, a target chain height of the target service subchain based on the chain height voting information and the subchain control contract; and
generating height confirmation information corresponding to the target chain height based on the subchain control contract, and transmitting the height confirmation information to a verification node in the target service subnetwork,
the height confirmation information being configured for the verification node to write, based on the height confirmation information, the target chain height into a subchain management contract on the target service subchain, the subchain management contract being configured to instruct the verification node to determine, based on the target chain height, a chain height obtained after execution of the target service.

2. The method according to claim 1, wherein the determining a target chain height of the target service subchain based on the chain height voting information and the subchain control contract comprises:
determining a voting type of the chain height voting information based on a node registration identity of the target registered node; and
determining the target chain height of the target service subchain based on the chain height voting information, the voting type of the chain height voting information, and the subchain control contract.

3. The method according to claim 2, wherein the chain height voting information comprises first-type height voting information of the management node for the target service subchain, the first-type height voting information comprising a node identifier of the management node, a public key certificate of the management node, a voted-for height generated when the management node performs voting on the chain height of the target service subchain, and signature information of the management node, the signature information of the management node being obtained by the management node after performing signature addition on the voted-for height based on private key information of the management node, the subchain control contract comprising node registration configuration information of a registered node associated with the target service subchain, the node registration configuration information comprising a node identifier of the registered node and a public key certificate of the registered node, the public key certificate of the registered node being obtained after the target consensus node performs, by invoking the subchain control contract, identity registration for registered node information submitted by the registered node; and
the determining a voting type of the chain height voting information based on a node registration identity of the target registered node further comprises:
obtaining the node identifier of the management node from the first-type height voting information, searching the node identifier of the registered node for a target node identifier the same as the node identifier of the management node, obtaining a public key certificate of the target registered node corresponding to the target node identifier from the public key certificate of the registered node, and using the obtained public key certificate of the target registered node as a target public key certificate;
using the public key certificate of the management node comprised in the first-type height voting information as a to-be-processed public key certificate, and performing signature verification on the signature information of the management node based on the to-be-processed public key certificate and the target public key certificate, to obtain a signature verification result of the management node;
determining the management node as the target registered node when the signature verification result of the management node indicates that the signature verification succeeds; and
determining a voting type of the first-type height voting information based on the node registration identity of the target registered node.

4. The method according to claim 3, wherein the performing signature verification on the signature information of the management node based on the to-be-processed public key certificate and the target public key certificate, to obtain a signature verification result of the management node, comprises:
using certificate data information in the to-be-processed public key certificate as to-be-processed certificate information, and using certificate data information in the target public key certificate as target certificate information;
comparing the to-be-processed certificate information with the target certificate information, to obtain a comparison result; and
performing, in response to the comparison result indicating the to-be-processed certificate information being consistent with the target certificate information, signature verification on the signature information of the management node based on public key information in the to-be-processed public key certificate, and using a verification result obtained when the signature verification succeeds as the signature verification result of the management node.

5. The method according to claim 3, wherein the node registration configuration information comprises a first-type node registration identity or a second-type node registration identity registered by the registered node for the target service subchain; and
the determining a voting type of the first-type height voting information based on the node registration identity of the target registered node comprises:
searching the node registration configuration information for the node registration identity of the target registered node corresponding to the target node identifier, and using the found node registration identity of the target registered node as a target node registration identity;
determining, when the target node registration identity is the first-type node registration identity, based on the first-type node registration identity, that the voting type of the first-type height voting information is a first voting type; and
determining, when the target node registration identity is the second-type node registration identity, based on the second-type node registration identity, that the voting type of the first-type height voting information is a second voting type.

6. The method according to claim 2, wherein the management node comprises a first-type management node and a second-type management node, the first-type management node being a management node registering the first-type node registration identity in the subchain control contract, and the second-type management node being a management node registering the second-type node registration identity in the subchain control contract, an identity level of the first-type node registration identity being higher than an identity level of the second-type node registration identity; and the chain height voting information comprises first-type height voting information of the first-type management node and the second-type management node for the target service subchain, the first-type height voting information comprising first chain height voting information of the first voting type determined by the first-type management node based on the first-type node registration identity, and second chain height voting information of the second voting type determined by the second-type management node based on the second-type node registration identity; and
the determining the target chain height of the target service subchain based on the chain height voting information, the voting type of the chain height voting information, and the subchain control contract comprises:
determining a voted-for height generated when the first-type management node performs voting on the chain height of the target service subchain as a first voted-for height, and determining a voted-for height generated when the second-type management node performs voting on the chain height of the target service subchain as a second voted-for height; and
invoking, based on the first voted-for height, the subchain control contract to determine a reference voting height threshold for the target service subchain, and determining the target chain height of the target service subchain based on the reference voting height threshold, the first voted-for height, and the second voted-for height.

7. The method according to claim 6, wherein when a quantity of the first-type management nodes is M1, a quantity of the first voted-for heights is M1, M1 being a positive integer; when a quantity of the second-type management nodes is M2, a quantity of the second voted-for heights is M2, M2 being a positive integer; and
the invoking, based on the first voted-for height, the subchain control contract to determine a reference voting height threshold for the target service subchain, and determining the target chain height of the target service subchain based on the reference voting height threshold, the first voted-for height, and the second voted-for height comprises:
invoking the subchain control contract to determine a first voted-for height having a minimum height in the M1 first voted-for heights as the reference voting height threshold of the target service subchain;
obtaining voted-for heights less than or equal to the reference voting height threshold from the M1 first voted-for heights and the M2 second voted-for heights, using the obtained voted-for heights as candidate voting heights, and using a voted-for height having a maximum height in the candidate voting heights as a target voted-for height; and
using voted-for heights greater than or equal to the target voted-for height in the M1 first voted-for heights and the M2 second voted-for heights as to-be-processed heights, and using the target voted-for height as the target chain height of the target service subchain when a quantity of the to-be-processed heights is greater than a vote count threshold, the vote count threshold being greater than or equal to (M1+M2)/2.

8. The method according to claim 1, wherein the generating height confirmation information corresponding to the target chain height based on the subchain control contract, and transmitting the height confirmation information to a verification node in the target service subnetwork comprises:
constructing a height confirmation transaction based on the chain height voting information and the target chain height, packaging the height confirmation transaction into a target block of the target chain when a transaction packaging condition associated with the target chain is satisfied, and submitting the target block comprising the height confirmation transaction onto the target chain;
invoking the subchain control contract on the target chain to execute the height confirmation transaction in the target block, to obtain the height confirmation information corresponding to the target chain height; and
transmitting the height confirmation information to the verification node in the target service subnetwork through a target cross-chain relay, the target cross-chain relay being configured to isolate the target service subnetwork and the target chain network.

9. The method according to claim 1, wherein the chain height voting information comprises second-type height voting information of the management node for the target service subchain, the second-type height voting information being determined by the management node when it is detected that a service risk exists on the target service subchain, the second-type height voting information comprising a voted-against height of the management node generated when the management node performs voting on the chain height of the target service subchain, and the second-type height voting information being in a first risk handling transaction determined by the management node based on a risk transaction, the risk transaction being generated by the management node based on the voted-against height; and the method further comprises:
writing, when obtaining the first risk handling transaction transmitted by the management node, the risk transaction indicated by the first risk handling transaction into the subchain control contract, determining a chain height greater than the voted-against height on the target service subchain as an invalid chain height, and generating subchain locking information associated with the risk transaction; and
transmitting the subchain locking information to the verification node in the target service subnetwork,
the subchain locking information being configured for the verification node to stop executing a risk service associated with the risk transaction, and for the verification node to perform, when receiving a second risk handling transaction submitted by a service management object associated with the target service subnetwork, risk elimination on the risk service based on the second risk handling transaction, and
the subchain locking information being further configured to instruct the verification node to set a service state of the target service subchain to a locked state, the target service subchain in the locked state stopping transaction chaining and stopping performing cross-chain interaction with a first chain and a second chain comprised in the multi-blockchain, both the first chain and the second chain being blockchains different from the target service subchain.

10. The method according to claim 9, further comprising:
invoking, when obtaining a risk release transaction transmitted by the service management object in response to that the risk service is successfully handled, the subchain control contract to execute the risk release transaction, to obtain risk release information configured for releasing the risk transaction, and transmitting the risk release information to the verification node,
the risk release information being configured for the verification node to use the voted-against height as the target chain height of the target service subchain, and restore the service state of the target service subchain from the locked state to an unlocked state; and the management node being configured to perform voting starting from a block corresponding to a chain height next to the target chain height when detecting that the risk release information exists on the target service subchain.

11. The method according to claim 1, further comprising:
reading, when obtaining a subchain data query request transmitted by the service object through a service terminal, the target chain height of the target service subchain based on the subchain control contract, and comparing a to-be-verified chain height indicated by the subchain data query request with the read target chain height, to obtain a comparison result; and
generating, when the comparison result indicates that the to-be-verified chain height is less than or equal to the target chain height, subchain query response information corresponding to the subchain data query request, and returning the subchain query response information to the service terminal, the subchain query response information being configured to indicate that the to-be-verified chain height queried by the service object is a confirmed chain height on the target service subchain.

12. A data processing method for a multi-blockchain, the multi-blockchain comprising a target chain and a target service subchain, a target chain network corresponding to the target chain being independent of a target service subnetwork corresponding to the target service subchain, the target service subnetwork being constructed by a target consensus node in the target chain network based on a target service requested by a service object, the method being performed by a verification node in the target service subnetwork, and the method comprising:
receiving height confirmation information corresponding to a target chain height of the target service subchain transmitted by the target consensus node, the height confirmation information being generated by the target consensus node based on a subchain control contract deployed on the target chain, the subchain control contract being configured for controlling the target service subchain, and the target chain height being determined by the target consensus node based on chain height voting information of the management node for the target service subchain and the subchain control contract and in response to determining, based on the subchain control contract, that the management node of the target chain is a target registered node; and the subchain control contract comprising the target registered node performing identity registration for the target service subchain; and
writing the target chain height corresponding to the height confirmation information into a subchain management contract on the target service subchain, and determining, based on the target chain height, the chain height obtained after execution of the target service.

13. The method according to claim 12, wherein the writing the target chain height corresponding to the height confirmation information into a subchain management contract on the target service subchain, and determining, based on the target chain height, the chain height obtained after execution of the target service comprises:
writing the target chain height corresponding to the height confirmation information to the subchain management contract, obtaining a buffer height synchronized from the target chain, and using a sum of the buffer height and the target chain height as a block production height threshold; and
invoking a subchain service contract on the target service subchain to execute the target service, to obtain a target service execution result, generating a proposal block with a target block height based on the target service execution result, and determining, based on the target block height and the block production height threshold, a chain height obtained after execution of the target service, the target block height being greater than the target chain height, and the target block height being less than or equal to the block production height threshold.

14. The method according to claim 13, further comprising:
using a chain height that is on the target service subchain and that is located after the target chain height as a to-be-confirmed chain height;
setting, based on the subchain management contract, a service state of the target service subchain to a locked state when the to-be-confirmed chain height reaches the block production height threshold and updated height confirmation information from the target consensus node for the to-be-confirmed chain height is not obtained; and
writing, when obtaining the updated height confirmation information transmitted by the target consensus node for the to-be-confirmed chain height, the to-be-confirmed chain height corresponding to the updated height confirmation information into the subchain management contract, and restoring the service state of the target service subchain from the locked state to an unlocked state.

15. The method according to claim 12, wherein the chain height voting information comprises second-type height voting information of the management node for the target service subchain, the second-type height voting information being determined by the management node when it is detected that a service risk exists on the target service subchain, the second-type height voting information comprising a voted-against height of the management node generated when the management node performs voting on the chain height of the target service subchain, and the second-type height voting information being in a first risk handling transaction determined by the management node based on a risk transaction, the risk transaction being generated by the management node based on the voted-against height; and the method further comprises:
stopping, upon receiving subchain locking information transmitted by the target consensus node, execution of a risk service associated with the risk transaction based on the subchain locking information, and setting the service state of the target service subchain to the locked state, both the first chain and the second chain being blockchains different from the target service subchain, and the subchain locking information being obtained after the target consensus node writes the risk transaction into the subchain control contract;
performing, upon receiving a second risk handling transaction submitted by a service management object associated with the target service subnetwork, risk elimination on the risk service based on the second risk handling transaction, and returning risk handling success information to the service management object, the risk handling success information being configured to instruct the service management object to transmit a risk release transaction to the target consensus node in response to that the risk service is successfully handled, the risk release transaction being configured to instruct the target consensus node to generate, based on the subchain control contract, risk release information configured for releasing the risk transaction; and
receiving the risk release information returned by the target consensus node, using the voted-against height as the target chain height of the target service subchain based on the risk release information, and restoring the service state of the target service subchain from the locked state to an unlocked state.

16. A data processing method for a multi-blockchain, the multi-blockchain comprising a target chain and a target service subchain, a target chain network corresponding to the target chain being independent of a target service subnetwork corresponding to the target service subchain, the target service subnetwork being constructed by a target consensus node in the target chain network based on a target service requested by a service object, the method being performed by a management node of the target chain, and the method comprising:
obtaining chain height voting information generated when the management node performs voting on a chain height of the target service subchain, a subchain control contract configured for controlling the target service subchain being deployed on the target chain, the subchain control contract comprising a target registered node performing identity registration for the target service subchain;
transmitting the chain height voting information to the target consensus node,
the chain height voting information being configured for the target consensus node to determine, when determining the management node as the target registered node based on the subchain control contract, a target chain height of the target service subchain based on the chain height voting information and the subchain control contract, and generate, based on the subchain control contract, height confirmation information corresponding to the target chain height, the height confirmation information being configured to be transmitted to a verification node in the target service subnetwork, the verification node being configured to write the target chain height corresponding to the height confirmation information into a subchain management contract on the target service subchain, the subchain management contract being configured to instruct the verification node to determine, based on the target chain height, a chain height obtained after execution of the target service; and
obtaining the target chain height from the subchain management contract, and performing voting on the target service subchain based on the target chain height.

17. A computer device, comprising: a processor and a memory,
the processor being connected to the memory, the memory being configured to store a computer program, and the processor being configured to invoke the computer program, to cause the computer device to perform the method according to claim 1.

18. A non-transitory computer-readable storage medium, having a computer program stored therein, the computer program being adapted to be loaded and executed by a processor, to cause e a computer device comprising the processor to perform the method according to claim 1.

19. A non-transitory computer-readable storage medium, having a computer program stored therein, the computer program being adapted to be loaded and executed by a processor, to cause e a computer device comprising the processor to perform the method according to claim 12.

20. A non-transitory computer-readable storage medium, having a computer program stored therein, the computer program being adapted to be loaded and executed by a processor, to cause e a computer device comprising the processor to perform the method according to claim 16.
